(19) United States
(12) Patent Application Publication
(10) Pub. No.: US 2024/0057647 A1
(43) Pub. Date: Feb. 22, 2024

(54) FOOD ADDITIVE AS A FLAVOR ENHANCER OR TEXTURE MODIFIER, AND METHOD OF MAKING THE SAME

(71) Applicant: Uppala Rajakaruna, Corvallis, OR (US)

(72) Inventor: Uppala Rajakaruna, Corvallis, OR (US)

(21) Appl. No.: 18/485,534

(22) Filed: Oct. 12, 2023

Related U.S. Application Data
(63) Continuation-in-part of application No. PCT/US2022/027733, filed on May 4, 2022.
(60) Provisional application No. 63/185,323, filed on May 6, 2021.

(51) Int. Cl. A23L 27/00; A23L 27/10; A23L 19/00; A21D 2/36; A23L 13/40; A23L 19/12; A23L 7/126; A23L 23/00; A23L 15/00; A23J 3/22

(52) U.S. Cl. CPC A23L 27/72; A23L 27/88; A23L 27/10; A23L 19/01; A21D 2/36; A23L 13/428; A23L 19/12; A23L 7/126; A23L 23/00; A23L 15/30; A23J 3/227

(57) ABSTRACT

A method of manufacturing food additives uses banana stem inner core (banana pseudostem) as a flavor enhancer, texture modifier, and/or process improvement additive. Such banana-pseudostem food additives can be used in food product recipes as taste modifiers, carriers of tasting agents, flavor enhancers, flavor retainers, flavor accepters, or flavoring agents. Also, such banana-pseudostem food additives can be used as texture modifiers, food product softeners, water retainers, volume modifiers, and color modifiers.

### CROSS REFERENCE TO RELATED APPLICATION

This application is a continuation-in-part of, and claims priority from, International Application No. PCT/US2022/027733, filed May 4, 2022, which claims priority from U.S. Provisional Patent Application No. 63/185,323, filed May 6, 2021. The entire disclosures of these application are incorporated by reference herein for all purposes.

### TECHNICAL FIELD

The field of this disclosure relates generally to food additives and food products and, in particular, to such food additives and products that comprise the inner tender core of the banana plant stem (also referred to as banana stem inner core or banana pseudostem) and to methods of producing or using the food additives and food products for food applications.

### BACKGROUND INFORMATION

For centuries, various natural and unnatural compositions or ingredients have been added to foods, beverages, and edible compositions to improve their taste. Although it has long been known that there are only few basic types of “tastes,” the biological and biochemical basis of taste perception has been poorly understood. Mostly, taste improving and taste modifying agents or additives have been discovered largely by simple trial and error processes.

The sense of taste includes five basic kinds of tastes: sweet, sour, salty, bitter, and savory (umami). How good a food tastes may be determined by a complex mixture of the above kinds of tastes and additional factors such as the intensity, richness, aroma, texture, and palatability.

Dairy products for example such as cheese and cream, which have characteristic richness and signature body, greatly contribute to how good a processed food will taste. The characteristic richness and the body of the milk is believed to drive intense richness of cheese and cream, but these milk-based products tend to be very rich in calories.

Practicality most sweeteners used in food are added with carbohydrates. Such carbohydrates add extra calories to the food product and change the physical appearance and palatability, etc. High intensity sweeteners such as aspartame and stevia are used in very minute quantities and at the same time need to use higher amounts of carriers such as carbohydrates, which are adding extra calories, to dilute the intensity of such sweeteners.

Table salt is widely used as a seasoning. It is mostly added in higher amounts because there are difficulties in controlling the accuracy with proper dilution without a suitable carrier. Excessive salt consumption is known to be linked to adult diseases such as high blood pressure, strokes, and heart attacks. Due to greater health consciousness in recent years, many low sodium processed food products have been proposed and commercialized. However, because table salt is often the backbone of flavor, foods with a reduced amount of salt tend to become unpopular because they are less satisfying after the quantity of their food taste has been reduced.

Saltiness and savory (umami) taste also tend to go in hand in hand. For example, monosodium glutamate (MSG) is widely used as a food additive or flavor enhancer to achieve good umami taste as well as some saltiness. Although MSG has been excessively used in most popular food products, it has drawn attention for potential adverse health effects and is currently considered as not suitable for use in health food products.

Many commercially available spice mixes have a very high level of salt and even contain monosodium glutamate to enhance the savory taste as previously discussed. Because most of such products are in powder form or are diluted in sauces, they carry high calories with the added signature body.

Bouillon cubes, mostly chicken and beef flavored cubes, are very popular in the market and provide very intense flavor and high amount of salt. Such products are generally in powder form or in paste form from which it is difficult to control the right amount in a food recipe, causing the food to have too salty or intense taste or not enough flavor.

The tastants as discussed above tend have very fast dissolving characteristics. Such tastants are inorganic chemicals and are very reactive with moisture, i.e., the tastants are very soluble and travel with the moisture. Therefore, those tastants will not last on the taste buds of the tongue of human being or any animal. To provide better or intense the taste, these tastants must be used in large quantities need more and more tastants and to keep the consumer of the food product satisfied. Thus, most food products contain very high amounts of sugar, salt and many other tastants. As a result, health advocates complain about high sugar consumption and high salt consumption, etc., so the food product industry looks for the ways to reduce the amounts of unhealthy tastants in their food products.

Overview of Disclosure

One aspect of this disclosure relates to taste enhancers developed using banana plant-stem inner core (banana pseudostem).

Another aspect of this disclosure relates to taste enhancers which control the intensity of taste provided to food products.

In one embodiment, an additive facilitates slow release of such tastants, helping to retain or repeatedly expose their taste on the taste buds of the tongue, which can help decrease or minimize the level of sugar, salt, any other tastants in the food products.

In this regard, banana plant-stem inner-core pseudostem is a structurally hemicellulose and cellulose tubing that are configured to carry water through the body of the banana plant. Such microstructural water tubing can be ideally useful to encapsulate or carry water dissolvable tastants. When the banana hemicellulose and cellulose tubing structures are filled with tastants and used as a food additive, the resulting food additive may act as a slow-release tasting agent. Such soft fibrous structures provide extra chewiness and slowly release the encapsulated moisture with its absorbed tastant as the food product is chewed.

Because the taste-carrying particles of such tastant-enhanced banana pseudostem provide intense and long-lasting taste in the food structure, the rest of the ingredients in the food structure may be provided with fewer or no tastants. Moreover, the total overall amount of tastants may be decreased because the flavor is continually released as the food is chewed.

Some embodiments relate to methods of manufacturing food additives using banana stem inner core (banana pseudostem) to be used in food product recipes as a flavor enhancer, texture modifier, and/or process improvement additive. Such banana-pseudostem food additives can be used as taste modifiers, carriers of tasting agents, flavor enhancers, flavor retainers, flavor accepters, and/or flavoring agents. Also, such banana pseudostem food additives can be used as texture modifiers, food product softeners, water retainers, volume modifiers, and/or color modifiers.

Another aspect of this disclosure relates to using banana pseudostem and to methods of treating it to encapsulate intense taste to use as a tasting agent, taste enhancer, slow taste-releasing additive, or texture modifier of a food additive or food product to minimize sugar, salt, or other tastants in an overall food product.

In one embodiment, a method of preparing a banana-pseudostem food additive comprises: removing outer layers of a banana plant stem to provide a banana pseudostem devoid of removed outer layers; optionally soaking the banana pseudostem in a first soaking aqueous medium; breaking up the banana pseudostem to produce banana-pseudostem particles so that greater than or equal to 60% of the banana-pseudostem particles have a size that is greater than or equal to 1 cu mm (0.000061 cu inch) and less than or equal to 16387 cu mm (1 cu inch); optionally soaking the banana-pseudostem particles in a second soaking aqueous medium; boiling the banana-pseudostem particles in a boiling aqueous medium, wherein banana pseudostem or banana-pseudostem particles are subjected to an acid treatment in one or more of the first soaking aqueous medium, the second soaking aqueous medium, or the boiling aqueous medium to provide a boiled banana-pseudostem particle mixture; reducing water from the boiled banana-pseudostem particle mixture to provide a water-reduced banana-pseudostem particle mixture having a water content that is from about 2% by weight to about 95% by weight; and adding an effective amount of one or more tastants to produce a banana-pseudostem food additive.

In an alternative embodiment, a method of preparing a banana-pseudostem food additive comprises: removing outer layers of a banana plant stem to provide a banana pseudostem devoid of removed outer layers; optionally soaking the banana pseudostem in a first soaking aqueous medium; boiling the banana pseudostem in a boiling aqueous medium, wherein banana pseudostem is subjected to an acid treatment in one or more of the first soaking aqueous medium or the boiling aqueous medium to provide a boiled banana-pseudostem mixture; breaking up the banana pseudostem to produce banana-pseudostem particles so that greater than or equal to 60% of the banana-pseudostem particles have a size that is greater than or equal to 1 cu mm (0.000061 cu inch) and less than or equal to 16387 cu mm (1 cu inch) to provide a boiled banana-pseudostem particle mixture; reducing water from the boiled banana-pseudostem particle mixture to provide a water-reduced banana-pseudostem particle mixture having a water content that is from about 2% by weight to about 95% by weight; and adding an effective amount of one or more tastants to produce a banana-pseudostem food additive.

In some additional, alternative, or selectively cumulative embodiments, a banana-pseudostem food additive comprises: boiled banana-pseudostem particles devoid of outer layers of the banana plant stem, wherein greater than or equal to 60% of the banana-pseudostem particles have a major dimension that is greater than or equal to 2 mm (0.08 inch) and less than or equal to 7 mm (0.28 inch), and wherein banana-pseudostem particles provide hemicellulose and cellulose tubing structures; a water content that is from about 5% by weight to about 95% by weight; and a tastant encapsulated within some of the hemicellulose and cellulose tubing structures, wherein the banana-pseudostem food additive is configured to have a shelf life that is greater than or equal to one month with or without added preservatives.

In some additional, alternative, or selectively cumulative embodiments, a plant-based meat product comprises: textured vegetable protein; boiled banana-pseudostem particles devoid of outer layers of the banana plant stem, wherein greater than or equal to 60% of the banana-pseudostem particles have a size that is greater than or equal to 1 cu mm (0.000061 cu inch) and less than or equal to 16387 cu mm (1 cu inch), and wherein the banana-pseudostem particles provide hemicellulose and cellulose tubing structures; a water content that is from about 5% by weight to about 95% by weight; and a tastant encapsulated within some of the hemicellulose and cellulose tubing structures, wherein greater than or equal to 1% of hemicellulose and cellulose tubing structures encapsulate a tastant.

In some additional, alternative, or selectively cumulative embodiments, a plant-based meat product comprises: pea or soy protein; boiled banana-pseudostem particles devoid of outer layers of the banana plant stem, wherein greater than or equal to 60% of the banana-pseudostem particles have a size that is greater than or equal to 1 cu mm (0.000061 cu inch) and less than or equal to 16387 cu mm (1 cu inch), and wherein the banana-pseudostem particles provide hemicellulose and cellulose tubing structures; a water content that is from about 5% by weight to about 95% by weight; and a tastant encapsulated within some of the hemicellulose and cellulose tubing structures, wherein greater than or equal to 1% of hemicellulose and cellulose tubing structures encapsulate a tastant.

In some additional, alternative, or selectively cumulative embodiments, a lab-grown meat product comprises: lab-grown meat; boiled banana-pseudostem particles devoid of outer layers of the banana plant stem, wherein greater than or equal to 60% of the banana-pseudostem particles have a size that is greater than or equal to 1 cu mm (0.000061 cu inch) and less than or equal to 16387 cu mm (1 cu inch), and wherein the banana-pseudostem particles provide hemicellulose and cellulose tubing structures; a water content that is from about 5% by weight to about 95% by weight; and a tastant encapsulated within some of the hemicellulose and cellulose tubing structures, wherein greater than or equal to 1% of hemicellulose and cellulose tubing structures encapsulate a tastant.

In some additional, alternative, or selectively cumulative embodiments, a method of preparing a taste-enhancing and/or texture-modifying food additive comprises providing banana plant stem, removing outer layers of the banana plant stem to provide its inner core (banana pseudostem) devoid of removed outer layers, optionally soaking the banana pseudostem in an aqueous medium, breaking up (separating, fragmenting, particlizing) the banana pseudostem into banana-pseudostem particles, boiling the banana-pseudostem particles in an aqueous medium for from 10 minutes to 120 minutes to provide a boiled banana-pseudostem particle mixture, removing from 10% to 90% by weight water from the boiled banana-pseudostem particle mixture to provide a water-reduced banana-pseudostem particle mixture and/or removing water from the boiled banana-pseudostem particle mixture to achieve a water content that is from about 2% to about 95% by weight to provide a water-reduced banana-pseudostem particle mixture, and adding effective amount of one or more tastants (tasting agents).

In some additional, alternative, or selectively cumulative embodiments, a method of preparing a taste-enhancing and/or texture-modifying food additive comprises providing banana plant stem, removing outer layers of the banana plant stem to provide its inner core (banana pseudostem) devoid of removed outer layers, optionally soaking the banana pseudostem in an aqueous medium, breaking up the banana pseudostem into banana-pseudostem particles, boiling the banana-pseudostem particles in an aqueous medium at an elevated pressure for from 2 minutes to 30 minutes to provide a boiled banana-pseudostem particle mixture, removing 10% to 90% by weight water from the boiled banana-pseudostem particle mixture, and adding effective amount of one or more tastants.

In some additional, alternative, or selectively cumulative embodiments, a method of preparing a taste-enhancing and/or texture-modifying food additive comprises providing banana plant stem, removing outer layers of the banana plant stem to provide its inner core (banana pseudostem) devoid of removed outer layers, optionally soaking the banana pseudostem in an aqueous medium, breaking up the banana pseudostem into banana-pseudostem particles so that greater than or equal to 70% of the banana-pseudostem particles have a size that is greater than or equal to 1 cu mm (0.000061 cu inch) and less than or equal to 16387 cu mm (1 cu inch), boiling the banana-pseudostem particles in an aqueous medium for 2 minutes to 120 minutes to provide a boiled banana-pseudostem particle mixture, removing 10% to 90% by weight water from the boiled banana-pseudostem particle mixture, and adding effective amount of one or more tastants (tasting agent).

In some additional, alternative, or selectively cumulative embodiments, a method of preparing a taste-enhancing and/or texture-modifying food additive comprises providing banana plant stem, removing outer layers of the banana plant stem to provide its inner core (banana pseudostem) devoid of removed outer layers, optionally soaking the banana pseudostem in an aqueous medium, breaking up the banana pseudostem into banana-pseudostem particles so that greater than or equal to 60% of the banana-pseudostem particles have a size that is greater than or equal to 8 cu mm (0.0005 cu inch) and less than or equal to 2048 cu mm (0.125 cu inch), boiling the banana-pseudostem particles in an aqueous medium for 2 minutes to 120 minutes to provide a boiled banana-pseudostem particle mixture, removing 10% to 90% by weight water from the boiled banana-pseudostem particle mixture, and adding effective amount of one or more tastants (tasting agent).

In some additional, alternative, or selectively cumulative embodiments, a method of preparing a taste-enhancing and/or texture-modifying food additive comprises providing banana plant stem, removing outer layers of the banana plant stem to provide its inner core (banana pseudostem) devoid of removed outer layers, optionally soaking the banana pseudostem in an aqueous medium, breaking up the banana pseudostem into banana-pseudostem particles so that greater than or equal to 60% of the banana-pseudostem particles have a size that is greater than or equal to 8 cu mm (0.0005 cu inch) and less than or equal to 2048 cu mm (0.125 cu inch), boiling the banana-pseudostem particles in an aqueous medium for 2 minutes to 120 minutes to provide a boiled banana-pseudostem particle mixture, removing 10% to 95% by weight water from the boiled banana-pseudostem particle mixture to provide a water-reduced mixture, adding effective amount of one or more tastants to the water reduced mixture to provide a pseudostem tastant mixture, and encapsulating the tastants by gelatinizing moisture in the pseudostem tastant mixture).

In some additional, alternative, or selectively cumulative embodiments, a method of preparing a plant-based meat product comprises: removing outer layers of a banana plant stem to provide a banana pseudostem devoid of removed outer layers; optionally soaking the banana pseudostem in a first soaking aqueous medium; breaking up the banana pseudostem to produce banana-pseudostem particles so that greater than or equal to 60% of the banana-pseudostem particles have a size that is greater than or equal to 1 cu mm (0.000061 cu inch) and less than or equal to 16387 cu mm (1 cu inch) and such that the banana-pseudostem particles provide hemicellulose and cellulose tubing structures; optionally soaking the banana-pseudostem particles in a second soaking aqueous medium; boiling the banana-pseudostem particles in a boiling aqueous medium, wherein banana pseudostem or banana-pseudostem particles are subjected to an acid treatment in one or more of the first soaking aqueous medium, the second soaking aqueous medium, or the boiling aqueous medium to provide a boiled banana-pseudostem particle mixture; reducing water from the boiled banana-pseudostem particle mixture to provide a water-reduced banana-pseudostem particle mixture having a water content that is from about 2% by weight to about 95% by weight; adding an effective amount of one or more tastants to produce a banana-pseudostem food additive such that greater than or equal to 1% of the hemicellulose and cellulose tubing structures encapsulate a tastant; and adding a pea or soy protein).

In some additional, alternative, or selectively cumulative embodiments, a method of preparing a plant-based meat product comprises: removing outer layers of a banana plant stem to provide a banana pseudostem devoid of removed outer layers; optionally soaking the banana pseudostem in a first soaking aqueous medium; breaking up the banana pseudostem to produce banana-pseudostem particles so that greater than or equal to 60% of the banana-pseudostem particles have a size that is greater than or equal to 1 cu mm (0.000061 cu inch) and less than or equal to 16387 cu mm (1 cu inch) and such that the banana-pseudostem particles provide hemicellulose and cellulose tubing structures; optionally soaking the banana-pseudostem particles in a second soaking aqueous medium; boiling the banana-pseudostem particles in a boiling aqueous medium, wherein banana pseudostem or banana-pseudostem particles are subjected to an acid treatment in one or more of the first soaking aqueous medium, the second soaking aqueous medium, or the boiling aqueous medium to provide a boiled banana-pseudostem particle mixture; reducing water from the boiled banana-pseudostem particle mixture to provide a water-reduced banana-pseudostem particle mixture having a water content that is from about 2% by weight to about 95% by weight; adding an effective amount of one or more tastants to produce a banana-pseudostem food additive such that greater than or equal to 1% of the hemicellulose and cellulose tubing structures encapsulate a tastant; and adding a textured vegetable protein).

In some additional, alternative, or selectively cumulative embodiments, a method of preparing a lab-grown meat product comprises: removing outer layers of a banana plant stem to provide a banana pseudostem devoid of removed outer layers; optionally soaking the banana pseudostem in a first soaking aqueous medium; breaking up the banana pseudostem to produce banana-pseudostem particles so that greater than or equal to 60% of the banana-pseudostem particles have a size that is greater than or equal to 1 cu mm (0.000061 cu inch) and less than or equal to 16387 cu mm (1 cu inch) and such that the banana-pseudostem particles provide hemicellulose and cellulose tubing structures; optionally soaking the banana-pseudostem particles in a second soaking aqueous medium; boiling the banana-pseudostem particles in a boiling aqueous medium, wherein banana pseudostem or banana-pseudostem particles are subjected to an acid treatment in one or more of the first soaking aqueous medium, the second soaking aqueous medium, or the boiling aqueous medium to provide a boiled banana-pseudostem particle mixture; reducing water from the boiled banana-pseudostem particle mixture to provide a water-reduced banana-pseudostem particle mixture having a water content that is from about 2% by weight to about 95% by weight; adding an effective amount of one or more tastants to produce a banana-pseudostem food additive such that greater than or equal to 1% of the hemicellulose and cellulose tubing structures encapsulate a tastant; and adding a lab-grown meat.

In some additional, alternative, or selectively cumulative embodiments, the banana-pseudostem is soaked and/or boiled in an acidic aqueous medium.

In some additional, alternative, or selectively cumulative embodiments, the banana-pseudostem is soaked and/or boiled in an acidic aqueous medium that is controlled to maintain a pH within a predetermined range.

In some additional, alternative, or selectively cumulative embodiments, the banana-pseudostem particles are soaked and/or boiled in an acidic aqueous medium.

In some additional, alternative, or selectively cumulative embodiments, the banana-pseudostem particles are soaked and/or boiled in an acidic aqueous medium that is controlled to maintain a pH within a predetermined range.

In some additional, alternative, or selectively cumulative embodiments, a method of preparing a taste-enhancing and/or texture-modifying food additive comprises providing banana plant stem, removing outer layers of the banana plant stem to provide its inner core (banana pseudostem) devoid of removed outer layers, breaking up the banana pseudostem into banana-pseudostem particles, boiling the banana-pseudostem particles in an acidic medium having a controlled pH between 4.0-6.5, and adding effective amounts of selected natural and/or chemical additives.

In some additional, alternative, or selectively cumulative embodiments, gelatinization is accomplished by addition of starch or gelatin with optional heating and/or further moisture removal.

In some additional, alternative, or selectively cumulative embodiments, greater than or equal to 70% of the banana-pseudostem particles have a size that is greater than or equal to 1 cu mm (0.000061 cu inch) and less than or equal to 16387 cu mm (1 cu inch.

In some additional, alternative, or selectively cumulative embodiments, greater than or equal to 80% of the banana-pseudostem particles have a size that is greater than or equal to 1 cu mm (0.000061 cu inch) and less than or equal to 16387 cu mm (1 cu inch.

In some additional, alternative, or selectively cumulative embodiments, greater than or equal to 90% of the banana-pseudostem particles have a size that is greater than or equal to 1 cu mm (0.000061 cu inch) and less than or equal to 16387 cu mm (1 cu inch).

In some additional, alternative, or selectively cumulative embodiments, greater than or equal to 95% of the banana-pseudostem particles have a size that is greater than or equal to 1 cu mm (0.000061 cu inch) and less than or equal to 16387 cu mm (1 cu inch).

In some additional, alternative, or selectively cumulative embodiments, greater than or equal to 99% of the banana-pseudostem particles have a size that is greater than or equal to 1 cu mm (0.000061 cu inch) and less than or equal to 16387 cu mm (1 cu inch).

In some additional, alternative, or selectively cumulative embodiments, greater than or equal to 8 cu mm (0.0005 cu inch) and less than or equal to 2048 cu mm (0.125 cu inch).

In some additional, alternative, or selectively cumulative embodiments, greater than or equal to 60% of the banana-pseudostem particles have a size that is greater than or equal to 8 cu mm (0.0005 cu inch) and less than or equal to 2048 cu mm (0.125 cu inch).

In some additional, alternative, or selectively cumulative embodiments, greater than or equal to 70% of the banana-pseudostem particles have a size that is greater than or equal to 8 cu mm (0.0005 cu inch) and less than or equal to 2048 cu mm (0.125 cu inch).

In some additional, alternative, or selectively cumulative embodiments, greater than or equal to 80% of the banana-pseudostem particles have a size that is greater than or equal to 8 cu mm (0.0005 cu inch) and less than or equal to 2048 cu mm (0.125 cu inch).

In some additional, alternative, or selectively cumulative embodiments, greater than or equal to 90% of the banana-pseudostem particles have a size that is greater than or equal to 8 cu mm (0.0005 cu inch) and less than or equal to 2048 cu mm (0.125 cu inch).

In some additional, alternative, or selectively cumulative embodiments, greater than or equal to 95% of the banana-pseudostem particles have a size that is greater than or equal to 8 cu mm (0.0005 cu inch) and less than or equal to 2048 cu mm (0.125 cu inch).

In some additional, alternative, or selectively cumulative embodiments, greater than or equal to 99% of the banana-pseudostem particles have a size that is greater than or equal to 8 cu mm (0.0005 cu inch) and less than or equal to 2048 cu mm (0.125 cu inch).

In some additional, alternative, or selectively cumulative embodiments, banana-pseudostem particles have a major dimension that is greater than or equal to 1 mm (0.04 inch) and less than or equal to 10 mm (0.4 inch).

In some additional, alternative, or selectively cumulative embodiments, greater than or equal to 70% of the banana-pseudostem particles have a major dimension that is greater than or equal to 1 mm (0.04 inch) and less than or equal to 10 mm (0.4 inch).

In some additional, alternative, or selectively cumulative embodiments, greater than or equal to 80% of the banana-pseudostem particles have a major dimension that is greater than or equal to 1 mm (0.04 inch) and less than or equal to 10 mm (0.4 inch).

In some additional, alternative, or selectively cumulative embodiments, greater than or equal to 90% of the banana-pseudostem particles have a major dimension that is greater than or equal to 1 mm (0.04 inch) and less than or equal to 10 mm (0.4 inch).

In some additional, alternative, or selectively cumulative embodiments, greater than or equal to 95% of the banana-pseudostem particles have a major dimension that is greater than or equal to 1 mm (0.04 inch) and less than or equal to 10 mm (0.4 inch).

In some additional, alternative, or selectively cumulative embodiments, greater than or equal to 99% of the banana-pseudostem particles have a major dimension that is greater than or equal to 1 mm (0.04 inch) and less than or equal to 10 mm (0.4 inch).

In some additional, alternative, or selectively cumulative embodiments, the banana-pseudostem particles have a major dimension that is greater than or equal to 2 mm (0.08 inch) and less than or equal to 7 mm (0.28 inch).

In some additional, alternative, or selectively cumulative embodiments, greater than or equal to 60% of the banana-pseudostem particles have a major dimension that is greater than or equal to 2 mm (0.08 inch) and less than or equal to 7 mm (0.28 inch).

In some additional, alternative, or selectively cumulative embodiments, greater than or equal to 70% of the banana-pseudostem particles have a major dimension that is greater than or equal to 2 mm (0.08 inch) and less than or equal to 7 mm (0.28 inch).

In some additional, alternative, or selectively cumulative embodiments, greater than or equal to 80% of the banana-pseudostem particles have a major dimension that is greater than or equal to 2 mm (0.08 inch) and less than or equal to 7 mm (0.28 inch).

In some additional, alternative, or selectively cumulative embodiments, greater than or equal to 90% of the banana-pseudostem particles have a major dimension that is greater than or equal to 2 mm (0.08 inch) and less than or equal to 7 mm (0.28 inch).

In some additional, alternative, or selectively cumulative embodiments, greater than or equal to 95% of the banana-pseudostem particles have a major dimension that is greater than or equal to 2 mm (0.08 inch) and less than or equal to 7 mm (0.28 inch).

In some additional, alternative, or selectively cumulative embodiments, greater than or equal to 99% of the banana-pseudostem particles have a major dimension that is greater than or equal to 2 mm (0.08 inch) and less than or equal to 7 mm (0.28 inch).

In some additional, alternative, or selectively cumulative embodiments, the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 50% of the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 60% of the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 70% of the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 80% of the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 90% of the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 95% of the banana-pseudostem particles have a major dimension that is greater than or equal to 2 mm (0.08 inch) and less than or equal to 4 mm (0.16 inch).

In some additional, alternative, or selectively cumulative embodiments, greater than or equal to 99% of the banana-pseudostem particles have a major dimension that is greater than or equal to 2 mm (0.08 inch) and less than or equal to 4 mm (0.16 inch).

In some additional, alternative, or selectively cumulative embodiments, the banana-pseudostem particles are boiled in the aqueous medium with an enzyme-reaction inhibitor that comprises a natural enzyme-reaction inhibitor or a natural spice.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises a chemical, biogenic, or acidic enzyme-reaction inhibitor.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises a plant-derived enzyme-reaction inhibitor.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that permits discoloration of the banana-pseudostem particles.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that permits substantial discoloration of the banana-pseudostem particles.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises a bitter-taste-deterring enzyme-reaction inhibitor.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises a bitter-taste-deterring enzyme-reaction inhibitor that permits discoloration of the banana-pseudostem particles.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises a bitter-taste-deterring enzyme-reaction inhibitor that permits substantial discoloration of the banana-pseudostem particles.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises one or more of turmeric, capsicum, salt, an acid, or sugar.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that consists essentially of one or more of a spice, turmeric, capsicum, salt, and sugar in an acidic medium.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises one or more of turmeric and capsicum.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that comprises turmeric and capsicum.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor that consists essentially of turmeric or capsicum.

In some additional, alternative, or selectively cumulative embodiments, the banana-pseudostem particles are treated in one or more of the first soaking aqueous medium, the second soaking aqueous medium, or the boiling aqueous medium with an enzyme-reaction inhibitor the enzyme-reaction inhibitor that consists essentially of turmeric and capsicum.

In some additional, alternative, or selectively cumulative embodiments, wherein the tastants are encapsulated within the banana-pseudostem particles by gelatinization to produce the banana-pseudostem food additive.

In some additional, alternative, or selectively cumulative embodiments, gelatinization employs additional heating.

In some additional, alternative, or selectively cumulative embodiments, gelatinization employs additional moisture removal.

In some additional, alternative, or selectively cumulative embodiments, gelatinization employs addition of starch or gelatin.

In some additional, alternative, or selectively cumulative embodiments, gelatinization employs addition of a plant-based gelatinizing agent.

In some additional, alternative, or selectively cumulative embodiments, gelatinization employs addition of a plant-based starch.

In some additional, alternative, or selectively cumulative embodiments, gelatinization employs addition of a plant-based starch, including one or more of tapioca flour, potato flour, corn flour, a gluten-based starch, xanthan gum, molt dextrin, a thickening agent, an oil, or a waxes.

In some additional, alternative, or selectively cumulative embodiments, gelatinization employs addition of a corn-based product.

In some additional, alternative, or selectively cumulative embodiments, gelatinization employs addition of corn starch or corn syrup.

In some additional, alternative, or selectively cumulative embodiments, the banana-pseudostem particles are boiled for greater than or equal to 10 minutes.

In some additional, alternative, or selectively cumulative embodiments, the banana-pseudostem particles are boiled for greater than or equal to 20 minutes.

In some additional, alternative, or selectively cumulative embodiments, the banana-pseudostem particles are boiled for greater than or equal to 30 minutes.

In some additional, alternative, or selectively cumulative embodiments, the banana-pseudostem particles are boiled for greater than or equal to 45 minutes.

In some additional, alternative, or selectively cumulative embodiments, the banana-pseudostem particles are boiled for greater than or equal to 60 minutes.

In some additional, alternative, or selectively cumulative embodiments, the banana-pseudostem particles are boiled for less than or equal to 120 minutes.

In some additional, alternative, or selectively cumulative embodiments, one or more of the first soaking aqueous medium, the second soaking aqueous medium, or the boiling aqueous medium has a pH that is greater than or equal to 2 and less than or equal to 6.5.

In some additional, alternative, or selectively cumulative embodiments, one or more of the first soaking aqueous medium, the second soaking aqueous medium, or the boiling aqueous medium has a pH that is greater than or equal to 4 and less than or equal to 6.5.

In some additional, alternative, or selectively cumulative embodiments, one or more of the first soaking aqueous medium, the second soaking aqueous medium, or the boiling aqueous medium has a pH that is greater than or equal to 6 and less than or equal to 8.

In some additional, alternative, or selectively cumulative embodiments, the banana-pseudostem or the banana-pseudostem particles are soaked in one or more of the first soaking aqueous medium or the second soaking aqueous medium for greater than or equal to 24 hours.

In some additional, alternative, or selectively cumulative embodiments, the banana-pseudostem or the banana-pseudostem particles are soaked in one or more of the first soaking aqueous medium or the second soaking aqueous medium for less than or equal to 24 hours.

In some additional, alternative, or selectively cumulative embodiments, the banana-pseudostem or the banana-pseudostem particles are soaked in one or more of the first soaking aqueous medium or the second soaking aqueous medium for greater than or equal to 72 hours.

In some additional, alternative, or selectively cumulative embodiments, the banana-pseudostem particles are soaked in soaked in one or more of the first soaking aqueous medium or the second soaking aqueous medium for less than or equal to 72 hours.

In some additional, alternative, or selectively cumulative embodiments, the banana-pseudostem particles are soaked in one or more of the first soaking aqueous medium or the second soaking aqueous medium for greater than or equal to 7 days.

In some additional, alternative, or selectively cumulative embodiments, the banana-pseudostem particles soaked in soaked in one or more of the first soaking aqueous medium or the second soaking aqueous medium for greater than or equal to 2 weeks.

In some additional, alternative, or selectively cumulative embodiments, the banana-pseudostem particles are soaked in one or more of the first soaking aqueous medium or the second soaking aqueous medium for less than or equal to 7 days.

In some additional, alternative, or selectively cumulative embodiments, the banana-pseudostem particles soaked in soaked in one or more of the first soaking aqueous medium or the second soaking aqueous medium for less than or equal to 2 weeks.

In some additional, alternative, or selectively cumulative embodiments, the banana-pseudostem particles are soaked in one or more of the first soaking aqueous medium or the second soaking aqueous medium for less than or equal to 4 weeks.

In some additional, alternative, or selectively cumulative embodiments, the banana-pseudostem particles are soaked in soaked in one or more of the first soaking aqueous medium or the second soaking aqueous medium for less than or equal to 4 months.

In some additional, alternative, or selectively cumulative embodiments, the first soaking aqueous medium, the second soaking aqueous medium, and the boiling aqueous medium have the same ingredients at the same concentrations.

In some additional, alternative, or selectively cumulative embodiments, one of the first soaking aqueous medium, the second soaking aqueous medium, and the boiling aqueous medium has different ingredients or has the same ingredients at different concentrations.

In some additional, alternative, or selectively cumulative embodiments, the step of breaking up the banana pseudostem to produce banana-pseudostem particles occurs before the step of boiling, allowing for effective enzyme deactivation process.

In some additional, alternative, or selectively cumulative embodiments, the step of breaking up the banana pseudostem to produce banana-pseudostem particles occurs after the step of boiling.

In some additional, alternative, or selectively cumulative embodiments, breaking up the banana-pseudostem includes one or more of cutting, mincing, grinding, and homogenization.

In some additional, alternative, or selectively cumulative embodiments, breaking up the banana-pseudostem includes one or more of cutting, mincing, grinding, and homogenization while the banana-pseudostem is wet.

In some additional, alternative, or selectively cumulative embodiments, breaking up the banana-pseudostem includes one or more of cutting, mincing, grinding, and homogenization into banana-pseudostem particles while the banana-pseudostem is wet, and then sifting the banana-pseudostem particles into a desirable size range while they are wet.

In some additional, alternative, or selectively cumulative embodiments, the banana-pseudostem particles are soaked at a temperature greater than or equal to 4.4444° C. (40° F.).

In some additional, alternative, or selectively cumulative embodiments, the banana-pseudostem particles are boiled at a temperature greater than or equal to 100° C. (212° F.).

In some additional, alternative, or selectively cumulative embodiments, the banana-pseudostem particles are boiled at a temperature greater than or equal to 104.444° C. (220° F.).

In some additional, alternative, or selectively cumulative embodiments, the banana-pseudostem particles are boiled at a temperature greater than or equal to 115.556° C. (240° F.).

In some additional, alternative, or selectively cumulative embodiments, the banana-pseudostem particles are boiled at a temperature greater than or equal to 121.111° C. (250° F.).

In some additional, alternative, or selectively cumulative embodiments, the banana-pseudostem particles are boiled at a temperature greater than or equal to 135° C. (275° F.).

In some additional, alternative, or selectively cumulative embodiments, the banana-pseudostem particles are boiled at a temperature greater than or equal to 104.444° C. (220° F.) and less than or equal to 148.889° C. (300° F.).

In some additional, alternative, or selectively cumulative embodiments, the banana-pseudostem particles are boiled at a pressure greater than 101.325 kilopascal (kPa) (1 atm).

In some additional, alternative, or selectively cumulative embodiments, the banana-pseudostem particles are boiled at a pressure greater than or equal to 202.650 kilopascal (kPa) (2 atm).

In some additional, alternative, or selectively cumulative embodiments, the banana-pseudostem particles are boiled at a pressure greater than 303.975 kilopascal (kPa) (3 atm).

In some additional, alternative, or selectively cumulative embodiments, the banana-pseudostem particles are boiled at a pressure greater than 506.625 kilopascal (kPa) (5 atm).

In some additional, alternative, or selectively cumulative embodiments, the banana-pseudostem particles are boiled at a temperature greater than or equal to 104.444° C. (220° F.) and less than or equal to 148.889° C. (300° F.) and at a pressure greater than 101.325 kilopascal (kPa) (1 atm).

In some additional, alternative, or selectively cumulative embodiments, a processing aid or an additional tastant is added during or after the step of adding tastants.

In some additional, alternative, or selectively cumulative embodiments, the processing aid comprises one or more of starch, vegetable oil, butter, cream, fatty acids, and animal fat.

In some additional, alternative, or selectively cumulative embodiments, the processing aid consists essentially of one or more of starch, vegetable oil, butter, cream, fatty acids, and animal fat.

In some additional, alternative, or selectively cumulative embodiments, an orally acceptable carrier is added after the step of water reduction.

In some additional, alternative, or selectively cumulative embodiments, an orally acceptable carrier comprises one or more of a colorant, an additional preservative, a sweetener, an emulsifier, and a processing aid.

In some additional, alternative, or selectively cumulative embodiments, an additional tastant is added after the step of adding tastants.

In some additional, alternative, or selectively cumulative embodiments, an additional tastant comprises one or more of an ingredient having a sweet taste, an ingredient having salty taste, an ingredient having bitter taste, an ingredient having sour taste, an ingredient having savory taste, an ingredient having spicy taste, and an ingredient having a creamy taste.

In some additional, alternative, or selectively cumulative embodiments, after the step of boiling the banana-pseudostem particles, they are subjected to further fragmentation or homogenization.

In some additional, alternative, or selectively cumulative embodiments, after the step of boiling the banana-pseudostem particles, they are subjected to heat.

In some additional, alternative, or selectively cumulative embodiments, after the step of boiling the banana-pseudostem particles, they are subject to high heat.

In some additional, alternative, or selectively cumulative embodiments, after the step of boiling the banana-pseudostem particles, they are subjected to a temperature greater than or equal to about 204.444 (400° F.).

In some additional, alternative, or selectively cumulative embodiments, after the step of boiling the banana-pseudostem particles, they are subjected to a temperature greater than or equal to about 260 (500° F.).

In some additional, alternative, or selectively cumulative embodiments, after the step of boiling the banana-pseudostem particles, they are subjected to a temperature less than or equal to about 315.556 (600° F.).

In some additional, alternative, or selectively cumulative embodiments, after the step of boiling the banana-pseudostem particles, subjected to a temperature greater than or equal to about 204.444 (400° F.) and less than or equal to about 315.556 (600° F.).

In some additional, alternative, or selectively cumulative embodiments, after the step of boiling the banana-pseudostem particles, they are subjected to greater than or equal to 1 kiloWatt per liter.

In some additional, alternative, or selectively cumulative embodiments, after the step of boiling the banana-pseudostem particles, they are subjected to further fragmentation or homogenization; and then they are subjected to heat.

In some additional, alternative, or selectively cumulative embodiments, after the step of boiling the banana-pseudostem particles, they are subjected to further fragmentation or homogenization; and then they are subjected to high heat.

In some additional, alternative, or selectively cumulative embodiments, after the step of boiling the banana-pseudostem particles, they are subjected to further fragmentation or homogenization; and then they are subjected to greater than or equal to 1 kiloWatt per liter.

In some additional, alternative, or selectively cumulative embodiments, after the step of boiling the banana-pseudostem particles, they are subjected to further fragmentation or homogenization; and then they are subjected to a temperature greater than or equal to about 204.444 (400° F.).

In some additional, alternative, or selectively cumulative embodiments, after the step of tastant addition, the water-reduced banana-pseudostem particle mixture is subjected to optional further size reduction and to homogenization and high heat to increase taste concentration and aroma.

In some additional, alternative, or selectively cumulative embodiments, an additional preservative is added to the boiled banana-pseudostem particle mixture or the water-reduced banana-pseudostem particle mixture.

In some additional, alternative, or selectively cumulative embodiments, an additional preservative including one or more of potassium sorbate, sodium metabisulfite, sodium pyrophosphate, sodium nitrate, sodium benzoate, BHT, or BHA is added to the boiled banana-pseudostem particle mixture or the water-reduced banana-pseudostem particle mixture.

In some additional, alternative, or selectively cumulative embodiments, reducing water from the boiled banana-pseudostem particles provides the water-reduced banana-pseudostem particle mixture with a water content that is from about 2% by weight to about 50% by weight.

In some additional, alternative, or selectively cumulative embodiments, reducing water from the boiled banana-pseudostem particles provides the water-reduced banana-pseudostem particle mixture with a water content that is from about 3% by weight to about 25% by weight.

In some additional, alternative, or selectively cumulative embodiments, reducing water from the boiled banana-pseudostem particles provides the water-reduced banana-pseudostem particle mixture with a water content that is from about 5% by weight to about 10% by weight.

In some additional, alternative, or selectively cumulative embodiments, reducing water from the boiled banana-pseudostem particles provides the water-reduced banana-pseudostem particle mixture with a water content that is from about 5% by weight to about 95% by weight.

In some additional, alternative, or selectively cumulative embodiments, reducing water from the boiled banana-pseudostem particles provides the water-reduced banana-pseudostem particle mixture with a water content that is greater than or equal to about 10% by weight to about 95% by weight.

In some additional, alternative, or selectively cumulative embodiments, the banana-pseudostem food additive provides a processed taste enhancer.

In some additional, alternative, or selectively cumulative embodiments, the banana-pseudostem food additive provides a processed taste enhancer having a water content greater than 50% by weight.

In some additional, alternative, or selectively cumulative embodiments, the banana-pseudostem food additive provides a processed taste enhancer configured to prepare a food product having 0.1% to 50% by weight of the processed taste enhancer.

In some additional, alternative, or selectively cumulative embodiments, the banana-pseudostem food additive provides a processed taste enhancer configured to prepare a food product having 10% to 25% by weight of the processed taste enhancer.

In some additional, alternative, or selectively cumulative embodiments, the banana-pseudostem food additive provides a processed taste enhancer configured to prepare a food product having 5% to 25% by weight of the processed taste enhancer.

In some additional, alternative, or selectively cumulative embodiments, the banana-pseudostem food additive contains from 0.1% to 99% by weight of banana-pseudostem.

In some additional, alternative, or selectively cumulative embodiments, the banan-pseudostem food additive contains from 5% to 99% by weight of banana pseudostem.

In some additional, alternative, or selectively cumulative embodiments, the banana-pseudostem food additive contains from 10% to 99% by weight of banana pseudostem.

In some additional, alternative, or selectively cumulative embodiments, the banana-pseudostem food additive contains from 15% to 99% by weight of banana pseudostem.

In some additional, alternative, or selectively cumulative embodiments, the banana-pseudostem food additive contains from 20% to 99% by weight of banana pseudostem.

In some additional, alternative, or selectively cumulative embodiments, the banana-pseudostem food additive contains from 25% to 99% by weight of banana pseudostem.

In some additional, alternative, or selectively cumulative embodiments, the banana-pseudostem food additive contains from 30% to 99% by weight of banana pseudostem.

In some additional, alternative, or selectively cumulative embodiments, the banana-pseudostem food additive contains from 50% to 99% by weight of banana pseudostem.

In some additional, alternative, or selectively cumulative embodiments, the banana-pseudostem food additive contains from 75% to 99% by weight of banana pseudostem.

In some additional, alternative, or selectively cumulative embodiments, the banana-pseudostem food additive contains from 0.1% to 99% by weight as a taste enhancer or texture modifier or additive in a food product wherein the food additive delivers the taste of sweet, bitter, salty, sour, savory, spicy or combination of such tastes to a food product.

In some additional, alternative, or selectively cumulative embodiments, the food product is one or more of a pastry, pasta, a bakery product, bread product, a sweet or savory filling, a sweet product, a sweet or savory topping, a potato product, a granola bar, a serial bar, chili paste, soup, juice, a sauce, a pickle, a chutney, a diary product, a gravy, a pet food, a laxative, a stool softener, a batter, a coating, a paste, a concentrate, and a meat product.

In some additional, alternative, or selectively cumulative embodiments, the food product is a lab-grown meat product.

In some additional, alternative, or selectively cumulative embodiments, the food product is a plant-based meat product.

In some additional, alternative, or selectively cumulative embodiments, the enzyme-reaction inhibitor comprises a bitter-taste-deterring enzyme-reaction inhibitor that permits discoloration of the banana-pseudostem particles, wherein the banana-pseudostem particles are boiled for greater than or equal to 10 minutes at a temperature greater than or equal to 104.444° C. (220° F.) and less than or equal to 148.889° C. (300° F.) and at a pressure greater than 101.325 kilopascal (kPa) (1 atm), wherein reducing water from the boiled banana-pseudostem particles provides the processed pseudostem with a water content that is greater than or equal to about 10% by weight to about 95% by weight, and wherein the banana-pseudostem food additive is configured for preparation of a food product having 0.1% to 50% by weight of the food additive.

In some additional, alternative, or selectively cumulative embodiments, the enzyme-reaction inhibitor comprises one or more of capsicum and turmeric, wherein the banana-pseudostem particles are boiled for greater than or equal to 10 minutes at a temperature greater than or equal to 104.444° C. (220° F.) and less than or equal to 148.889° C. (300° F.) and at a pressure greater than 101.325 kilopascal (kPa) (1 atm), wherein reducing water from the boiled banana-pseudostem particles provides the water-reduced banana-pseudostem particle mixture with a water content that is greater than or equal to about 10% by weight to about 95% by weight, and wherein the banana-pseudostem food additive is configured for preparation of a food product having 0.1% to 50% by weight of the food additive.

In some additional, alternative, or selectively cumulative embodiments, the banana-pseudostem food additive has a shelf life that is greater than or equal to 1 day.

In some additional, alternative, or selectively cumulative embodiments, the banana-pseudostem food additive has a shelf life that is greater than or equal to 10 days.

In some additional, alternative, or selectively cumulative embodiments, the banana-pseudostem food additive has a shelf life that is greater than or equal to 30 days.

In some additional, alternative, or selectively cumulative embodiments, the banana-pseudostem food additive has a shelf life that is greater than or equal to 2 months.

In some additional, alternative, or selectively cumulative embodiments, the banana-pseudostem food additive has a shelf life that is greater than or equal to 4 months.

In some additional, alternative, or selectively cumulative embodiments, the banana-pseudostem food additive has a shelf life that is greater than or equal to 6 months.

In some additional, alternative, or selectively cumulative embodiments, the banana-pseudostem food additive has a shelf life that is greater than or equal to 12 months.

In some additional, alternative, or selectively cumulative embodiments, the banana-pseudostem food additive has a shelf life that is greater than or equal to 18 months.

In some additional, alternative, or selectively cumulative embodiments, the banana-pseudostem food additive has a shelf life that is greater than or equal to 24 months.

In some additional, alternative, or selectively cumulative embodiments, the banana-pseudostem food additive functions as one or more of a flavor enhancer, a texture modifier, and a slow taste-releasing agent.

In some additional, alternative, or selectively cumulative embodiments, the tastant is encapsulated within banana-pseudostem particles by gelatinization by an adding effective amount of one or more of starch, gelatin, oil, or a processing aid.

In some additional, alternative, or selectively cumulative embodiments, the tastant is encapsulated within banana-pseudostem particles by gelatinization by an adding effective amount of one or more of starch, gelatin, oil, or a processing aid to provide a gelatinized pseudostem-tastant mixture, wherein the gelatinized pseudostem-tastant mixture is heated and its moisture content is further reduced.

In some additional, alternative, or selectively cumulative embodiments, greater than or equal to 60% of the banana-pseudostem particles have a size that is greater than or equal to 8 cu mm (0.0005 cu inch) and less than or equal to 2048 cu mm (0.125 cu inch), wherein the tastant is encapsulated within banana-pseudostem particles by gelatinization, wherein the tastant comprises salt or sugar, wherein the banana-pseudostem food additive permits reduction of a total amount of sugar, salt, and/or calorie reduction in a food product containing the banana-pseudostem food additive.

In some additional, alternative, or selectively cumulative embodiments, effective amounts of selected natural and/or chemical additives are added to the boiled banana-pseudostem particle mixture, water-reduced mixture, or the pseudostem tastant mixture.

In some additional, alternative, or selectively cumulative embodiments, the natural additives comprise one or more spices.

In some additional, alternative, or selectively cumulative embodiments, the spices comprise one or both of turmeric and capsicum.

In some additional, alternative, or selectively cumulative embodiments, the chemical additives comprise one or more there of salt (sodium chloride), sugar, an artificial sweetner, potassium sorbate or sodium metabisulfite.

In some additional, alternative, or selectively cumulative embodiments, the natural additives comprise one or more spices and one or more starches or oils.

In some additional, alternative, or selectively cumulative embodiments, the banana pseudostem or the banana-pseudostem particles are boiled after they have been preserved for 24-72 hours in an acidic medium having a pH lower than or equal to 6.5.

In some additional, alternative, or selectively cumulative embodiments, the banana pseudostem or the banana-pseudostem particles are boiled after they have been preserved, treated, or soaked for 1 day-60 days.

In some additional, alternative, or selectively cumulative embodiments, 10% to 90% by weight water is removed from the boiled banana-pseudostem particle mixture to provide the water-reduced mixture.

In some additional, alternative, or selectively cumulative embodiments, the tastants comprise one or more of a sugar, a salt, a spice, monosodium glutamate, milk, cream, vegetable oil, animal fat, starch, a savory broth, soy sauce, citric acid, and acetic acid.

In some additional, alternative, or selectively cumulative embodiments, the tastants comprise one or more of a sugar, a salt, a spice, monosodium glutamate, milk, cream, a savory broth, soy sauce, citric acid, acetic acid, starch, and oil, and wherein additional water is removed by heating and homogenizing.

In some additional, alternative, or selectively cumulative embodiments, a food product comprises a food additive prepared by any one of the methods described herein.

In some additional, alternative, or selectively cumulative embodiments, a food additive comprises an effective amount of the inner core of a banana plant stem (devoid of removed outer layers) and a tastant providing taste of sweet, salt, sour, bitter, savory, or one or more thereof.

In some additional, alternative, or selectively cumulative embodiments, one or more of tomato sauce, soy sauce, cheese, and cream, or the like, is added to the pseudostem tastant mixture to increase the food aroma and aromatic taste.

In some additional, alternative, selectively cumulative embodiments, taste-enhancing food additives or texture-modifying food additives prepared using banana stem pseudostem particles have the property of slow releasing of the taste from the food additive such that the food product uses less amount of a total given tastant, such as sugar or salt, than a comparable food product that does not use banana stem pseudostem particles.

In some additional, alternative, selectively cumulative embodiments, the banana-pseudostem or the banana pseudostem particles are soaked in the first soaking medium or the second soaking medium; wherein greater than or equal to 60% of the banana-pseudostem particles have a size that is greater than or equal to 8 cu mm (0.0005 cu inch) and less than or equal to 2048 cu mm (0.125 cu inch); wherein the banana-pseudostem particles are boiled for longer than or equal to 2 minutes at a temperature greater than or equal to 104.444° C. (220° F.); wherein the tastant comprises one or more of an ingredient having a sweet taste, an ingredient having salty taste, an ingredient having bitter taste, an ingredient having sour taste, an ingredient having savory taste, an ingredient having spicy taste, or an ingredient having a creamy taste; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

In some additional, alternative, selectively cumulative embodiments, the banana-pseudostem or the banana pseudostem particles are soaked in the first soaking medium or the second soaking medium; wherein greater than or equal to 60% of the banana-pseudostem particles have a major dimension that is greater than or equal to 2 mm (0.08 inch) and less than or equal to 7 mm (0.28 inch); wherein the banana-pseudostem particles are boiled for longer than or equal to 10 minutes at a temperature greater than or equal to 104.444° C. (220° F.) and at a pressure greater than 101.325 kilopascal (kPa) (1 atm); wherein the tastant comprises one or more of an ingredient having a sweet taste, an ingredient having salty taste, an ingredient having bitter taste, an ingredient having sour taste, an ingredient having savory taste, an ingredient having spicy taste, or an ingredient having a creamy taste; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

In some additional, alternative, selectively cumulative embodiments, the banana-pseudostem or the banana pseudostem particles are soaked in the first soaking medium or the second soaking medium; wherein the first soaking medium, the second soaking medium, and/or the boiling medium includes an enzyme-reaction inhibitor; wherein greater than or equal to 60% of the banana-pseudostem particles have a size that is greater than or equal to 8 cu mm (0.0005 cu inch) and less than or equal to 2048 cu mm (0.125 cu inch); wherein the banana-pseudostem particles are boiled for longer than or equal to 2 minutes at a temperature greater than or equal to 104.444° C. (220° F.); wherein the tastant comprises one or more of an ingredient having a sweet taste, an ingredient having salty taste, an ingredient having bitter taste, an ingredient having sour taste, an ingredient having savory taste, an ingredient having spicy taste, or an ingredient having a creamy taste; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

In some additional, alternative, selectively cumulative embodiments, the banana-pseudostem or the banana pseudostem particles are soaked in the first soaking medium or the second soaking medium; wherein the first soaking medium, the second soaking medium, and/or the boiling medium includes an enzyme-reaction inhibitor; wherein greater than or equal to 60% of the banana-pseudostem particles have a major dimension that is greater than or equal to 2 mm (0.08 inch) and less than or equal to 7 mm (0.28 inch); wherein the banana-pseudostem particles are boiled for longer than or equal to 10 minutes at a temperature greater than or equal to 104.444° C. (220° F.) and at a pressure greater than 101.325 kilopascal (kPa) (1 atm); wherein the tastant comprises one or more of an ingredient having a sweet taste, an ingredient having salty taste, an ingredient having bitter taste, an ingredient having sour taste, an ingredient having savory taste, an ingredient having spicy taste, or an ingredient having a creamy taste; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

In some additional, alternative, selectively cumulative embodiments, the banana-pseudostem or the banana pseudostem particles are soaked in the first soaking medium or the second soaking medium; wherein greater than or equal to 60% of the banana-pseudostem particles have a size that is greater than or equal to 8 cu mm (0.0005 cu inch) and less than or equal to 2048 cu mm (0.125 cu inch); wherein the banana-pseudostem particles are boiled for longer than or equal to 2 minutes at a temperature greater than or equal to 104.444° C. (220° F.); wherein the tastant comprises one or more of sugar or salt; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

In some additional, alternative, selectively cumulative embodiments, the banana-pseudostem or the banana pseudostem particles are soaked in the first soaking medium or the second soaking medium; wherein the first soaking medium, the second soaking medium, and/or the boiling medium includes an enzyme-reaction inhibitor; wherein greater than or equal to 60% of the banana-pseudostem particles have a major dimension that is greater than or equal to 2 mm (0.08 inch) and less than or equal to 7 mm (0.28 inch); wherein the banana-pseudostem particles are boiled for longer than or equal to 10 minutes at a temperature greater than or equal to 104.444° C. (220° F.) and at a pressure greater than 101.325 kilopascal (kPa) (1 atm); wherein the tastant comprises one or more of sugar or salt; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

In some additional, alternative, selectively cumulative embodiments, a banana pseudostem food additive comprises: boiled banana-pseudostem particles devoid of banana plant stem outer layers; a water content that is from about 2% by weight to about 95% by weight; and one or more of capsicum, turmeric, salt, and sugar.

In some additional, alternative, selectively cumulative embodiments, a food product comprises: 0.1% to 50% by weight of a banana-pseudostem food additive; wherein the banana-pseudostem food additive comprises: boiled banana-pseudostem particles devoid of banana plant stem outer layers; a water content that is from about 2% by weight to about 95% by weight; and one or more of capsicum, turmeric, salt, and sugar.

In some additional, alternative, selectively cumulative embodiments, the banana-pseudostem particles provide hemicellulose and cellulose tubing structures, and wherein greater than or equal to 5% of hemicellulose and cellulose tubing structures encapsulate a tastant.

In some additional, alternative, selectively cumulative embodiments, the banana-pseudostem particles provide hemicellulose and cellulose tubing structures, and wherein greater than or equal to 10% of hemicellulose and cellulose tubing structures encapsulate a tastant.

In some additional, alternative, selectively cumulative embodiments, the banana-pseudostem particles provide hemicellulose and cellulose tubing structures, and wherein greater than or equal to 20% of hemicellulose and cellulose tubing structures encapsulate a tastant.

In some additional, alternative, selectively cumulative embodiments, the banana-pseudostem particles provide hemicellulose and cellulose tubing structures, and wherein greater than or equal to 50% of hemicellulose and cellulose tubing structures encapsulate a tastant.

In some additional, alternative, selectively cumulative embodiments, the banana-pseudostem particles provide hemicellulose and cellulose tubing structures, and wherein greater than or equal to 75% of hemicellulose and cellulose tubing structures encapsulate a tastant.

In some additional, alternative, selectively cumulative embodiments, a food product comprises: a banana-pseudostem food additive having: boiled banana-pseudostem particles devoid of outer layers of the banana plant stem, wherein greater than or equal to 60% of the banana-pseudostem particles have a major dimension that is greater than or equal to 2 mm (0.08 inch) and less than or equal to 7 mm (0.28 inch), and wherein the banana-pseudostem particles provide hemicellulose and cellulose tubing structures; a water content that is from about 5% by weight to about 95% by weight; and a tastant encapsulated within some of the hemicellulose and cellulose tubing structures; and 5% to 30% less of the tastant than an equivalent food product has of the tastant.

In some additional, alternative, selectively cumulative embodiments, a food product comprises 5% to 25% less of the tastant than an equivalent food product has of the tastant.

In some additional, alternative, selectively cumulative embodiments, a food product comprises 5% to 15% less of the tastant than an equivalent food product has of the tastant.

In some additional, alternative, selectively cumulative embodiments, a food product comprises 5% to 10% less of the tastant than an equivalent food product has of the tastant.

Selectively cumulative embodiments are embodiments that include any combination of multiple embodiments that are not mutually exclusive.

Additional aspects and advantages will be apparent from the following detailed description of example embodiments, which proceeds with reference to the accompanying examples and recipes.

### DETAILED DESCRIPTION OF EMBODIMENTS

Example embodiments are described below with reference to the accompanying recipes. Unless otherwise expressly stated, the amount of ingredients is not necessarily to be exact. Some common ingredients can be replaced with conventional substitutes. For example, palm oil can be replaced or substituted with sunflower oil, brown sugar can be replaced with honey etc. The amounts of these substitutes may be disproportionate for recipe optimization.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” “comprising,” “includes,” “include,” “including,” “have,” “has,” and having” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are used only to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Similarly, the term “effective amount” refers to the amount of an ingredient or component (e.g. processed inner core of a banana plant stem) required to provide a desired effect.

Many different forms and embodiments are possible without deviating from the spirit and teachings of this disclosure and so this disclosure should not be construed as limited to the example embodiments set forth herein.

In the absence of more controllable, less caloric, better-textured food flavor enhancement additives, a new taste-enhancing and/or texture-modifying food additive has been developed to support the food processing industry. In particular, the applicant has discovered that taste-enhancing, taste-sustaining, and/or texture-modifying food additives that enhance the taste and/or modify texture may be prepared using banana plant stem inner core, which is also referred to as “banana pseudostem.” For convenience, the terms “banana plant stem inner core,” “banana plant inner core,” “banana inner core,” “inner core,” “banana plant pseudostem,” “banana pseudostem,” and “pseudostem,” may be used interchangeably.

The banana plant stem is part of the herbaceous banana plant. The banana plant stem is often described as having outer sheaths, inner sheaths, and an inner core. The outer and inner sheaths (or layers) of the banana plant stem (stalk) account for about ⅔ of the banana plant stem, with the inner core accounting for about only ⅓ of the banana plant stem. The sheaths are hard and contain a higher percentage of hard cellulosic fibrous skins that are mostly processed to obtain fibers for paper or yarn manufacturing. The inner core is, however, softer and contains a relatively lower amount of cellulose and has a softer structure without the harder cellulosic structures. This banana inner core is often included with the outer sheaths to obtain fibers even though the inner core itself has relatively low cellulosic content.

To a much lesser extent, the banana inner core is used as a fresh vegetable (as fresh as possible) with very limited shelf life in many Asian countries. The banana pseudostem is thus a large biomass resource that is usually wasted or underutilized. Part of the problem of using banana pseudostem on a large commercial scale as a food product, in a food product, or as a food additive is that it quickly turns to a dark color or black due to oxidation or enzyme reactions, becoming bitter in taste with minimal value as or in a food product. Unfortunately, there are very limited practices available to maintain freshness and avoid oxidation while maintaining the value as or in a food product, so the life as or a food product is limited to a very short period of time.

International Publication No. WO2015053810 and U.S. Pat. No. 10,946,058 for “Food Additives and Methods of Making and Using the Same,” the texts of which is herein incorporated by reference, describe a method for making a fiber food additive with banana plant stem inner core. In these patent documents, the banana stem inner core is treated with acidic solution in deactivating enzyme reaction steps, preventing or minimizing an enzyme reaction and/or oxidation that causes both bitterness and darkening.

However, the banana plant stem inner core can also be efficiently treated by particle size reduction, optionally adding one or more selective preservation additives (also called enzyme-deactivating agents, enzyme reaction inhibitors, enzyme oxidation inhibitors, and masking agents), boiling in a mild acidic medium or non-acidic medium, reducing the water content, and then adding one or more tastants such as salt, sugar, citric acid, acetic acid, savory tastants such as monosodium glutamate, soy sauce, fish sauce, milk products etc. to achieve desirable complex tastes. In this alternative process, the color may be sacrificed as the product may turn into a darker color; however, the increased bitterness is substantially prevented. The taste variation that occurs due to the addition of the preservation additives can be easily overcome by the tastants added, which dominate over the tastes of the reaction inhibitor(s).

In general, the inner core may be washed prior to and/or after breaking it into banana-pseudostem particles and before putting into an aqueous medium for soaking or boiling.

The outer and inner sheaths of the banana plant stem are removed, typically by cutting and are discarded or saved for other purposes, such as for paper or yarn manufacturing or for use as a combustion material to provide heat, steam, or power to boiling vessels.

The remaining banana pseudostem devoid of the outer layers may be treated or preserved in an acidic medium having a pH lower than or equal to 6.8 often for about 2 hours to up to about 120 days or three months. One will appreciate, however, that the entire banana plant stem may be preserved or treated in this manner with removal of the outer layers occurring later, or the banana pseudostem may be broken up into banana-pseudostem particles, as later described, prior to treatment or preservation. Treatment or preservation for greater than or equal to about three months (up to about six months) generally entails greater acidity such as a pH lower than or equal to 6.5. Excess acidity can be washed away, if needed, prior to boiling, such as before or after outer layer removal, or before or after breaking up the banana pseudostem into banana-pseudostem particles.

Thus, in some embodiments, the inner core (or banana-pseudostem particles) may be soaked in an aqueous medium with or without one or more of the acidity or preservative(s) (enzyme inhibitors) prior to boiling. In some embodiments, the inner core (or banana-pseudostem particles) may be soaked in an aqueous medium for greater than or equal to about 2 hours. In some embodiments, the inner core (or banana-pseudostem particles) may be soaked in an aqueous medium for greater than or equal to about 4 hours. In some embodiments, the inner core (or banana-pseudostem particles) may be soaked in an aqueous medium for greater than or equal to about 6 hours. In some embodiments, the inner core (or banana-pseudostem particles) may be soaked in an aqueous medium for greater than or equal to about 8 hours. In some embodiments, the inner core (or banana-pseudostem particles) may be soaked in an aqueous medium for greater than or equal to about 24 hours. In some embodiments, the inner core (or banana-pseudostem particles) may be soaked in an aqueous medium for greater than or equal to about 72 hours. In some embodiments, the inner core (or banana-pseudostem particles) may be soaked in an aqueous medium for greater than or equal to about 7 days. In some embodiments, the inner core (or banana-pseudostem particles) may be soaked in an aqueous medium for greater than or equal to about 2 weeks. In some embodiments, the inner core (or banana-pseudostem particles) may be soaked in an aqueous medium for greater than or equal to about 1 month. In some embodiments, the inner core (or banana-pseudostem particles) may be soaked in an aqueous medium for greater than or equal to about 2 months.

In some embodiments, the inner core (or banana-pseudostem particles) may be soaked in an aqueous medium for less than or equal to about 6 hours. In some embodiments, the inner core (or banana-pseudostem particles) may be soaked in an aqueous medium for less than or equal to about 8 hours. In some embodiments, the inner core (or banana-pseudostem particles) may be soaked in an aqueous medium for less than or equal to about 24 hours. In some embodiments, the inner core (or banana-pseudostem particles) may be soaked in an aqueous medium for less than or equal to about 72 hours. In some embodiments, the inner core (or banana-pseudostem particles) may be soaked in an aqueous medium for less than or equal to about 7 days. In some embodiments, the inner core (or banana-pseudostem particles) may be soaked in an aqueous medium for less than or equal to about 2 weeks. In some embodiments, the inner core (or banana-pseudostem particles) may be soaked in an aqueous medium for less than or equal to about 1 month. In some embodiments, the inner core (or banana-pseudostem particles) may be soaked in an aqueous medium for less than or equal to about 2 months. In some embodiments, the inner core (or banana-pseudostem particles) may be soaked in an aqueous medium for less than or equal to about 4 months.

In some embodiments, the inner core (or banana-pseudostem particles) may be soaked in an aqueous medium for from about 2 hours to about 8 hours. In some embodiments, the inner core (or banana-pseudostem particles) may be soaked in an aqueous medium for from about 2 hours to about 72 hours. In some embodiments, the inner core (or banana-pseudostem particles) may be soaked in an aqueous medium for from about 1 hour to about 2 hours. In some embodiments, the inner core (or banana-pseudostem particles) may be soaked in an aqueous medium for from about 3.5 hours to about 6.5 hours. In some embodiments, the inner core (or banana-pseudostem particles) may be soaked in an aqueous medium for about 4 to 5 hours. In some embodiments, the inner core (or banana-pseudostem particles) may be soaked in an aqueous medium for from about 1 day to about 7 days. In some embodiments, the inner core (or banana-pseudostem particles) may be soaked in an aqueous medium for from about 1 day to about 30 days. In some embodiments, the inner core (or banana-pseudostem particles) may be soaked in an aqueous medium for from about 1 week to about 8 weeks. In some embodiments, the inner core (or banana-pseudostem particles) may be soaked in an aqueous medium for from about 1 week to about 16 weeks.

In some embodiments, the inner core (or banana-pseudostem particles) may be soaked before it is broken up into banana-pseudostem particles. In other embodiments, the inner core may be broken up into chunks of banana-pseudostem particles larger than the particle sizes and/or major dimensions later described before being soaked. In yet other embodiments, the inner core may be broken up into banana-pseudostem particles of the particle sizes and/or major dimensions later described before being soaked.

In some embodiments, the soaking medium may be acidic or sufficiently acidic to cause to cause fermentation of the banana pseudostem or the banana-pseudostem particles. One may appreciate that it is possible to use some common food preservatives added in to the aqueous medium to maintain the acidity level below 7 pH. By soaking, the banana pseudostem (or banana-pseudostem particles) may be subjected to acid fermentation which provides good taste properties as well as well as preservation. Although one may appreciate that acidification may be employed solely in the boiling process for some products, soaking the inner core (or banana-pseudostem particles) before boiling is advantageous for many food additives and food products.

In some embodiments, the aqueous medium in which the inner core or banana-pseudostem particles may be soaked, treated, and/or boiled comprises one or more acids or acidifiers selected from acetic acid, citric acid, ascorbic acid, lactic acid, sulfuric acid, hydrochloric acid, turmeric, capsicum, salt, and sugar. In some embodiments, the aqueous medium in which the inner core or banana-pseudostem particles may be soaked, treated, and/or boiled comprises one or more acids or acidifiers selected from acetic acid, citric acid, ascorbic acid, lactic acid, sulfuric acid, hydrochloric acid. Moreover, acidification of the soaking medium (or a later described boiling medium) may be accomplished with one or more of any food-product-suitable acidifiers or acids. The acidifiers may be natural or synthetic. Natural acidifiers may include turmeric, capsicum, or acetic acid.

In some embodiments, the aqueous medium in which the inner core or banana-pseudostem particles may be soaked, treated, and/or boiled further comprises a component selected from calcium chloride, sodium chloride, potassium chloride, sodium carbonate, sodium bicarbonate, potassium carbonate, sodium hydroxide or potassium hydroxide; and a combination of two or more thereof. In some embodiments, the aqueous medium in which the inner core or banana-pseudostem particles may be boiled comprises the ingredient in a quantity sufficient to adjust the pH of the aqueous medium in which the inner core or banana-pseudostem or its particles may be soaked, treated, and/or boiled in between 3 to 8. In some embodiments, the aqueous medium in which the inner core or banana-pseudostem particles may be soaked, treated, and/or boiled comprises the ingredient in a quantity sufficient to deactivate the enzyme reaction.

For some embodiments, it may be desirable for the banana pseudostem (or the banana-pseudostem particles) to be subjected to soaking or treatment in an acidic solution, such as at a pH in a about a range between about 3 and about 6.8, for 1 day up to 16 weeks, preferably 1 week to 4 weeks. This soaking or treatment may provide some acid fermentation and may improve the taste while minimizing the enzyme reaction and darkening. The acidic treatment before the boiling process may be so effective for some food products that when the banana pseudostem (or the banana-pseudostem particles) are soaked or treated in this manner, an acid treatment may be omitted during the boiling process. Nevertheless, at least one acid treatment is desirable, either before boiling or during boiling or both before and during boiling; and, the acid treatment may be conducted before breaking up the banana pseudostem or after the banana pseudostem is broken up into banana-pseudostem particles, as subsequently described.

For most embodiments, the banana pseudostem is broken up (fragemented or separated) into smaller particles. Breaking up the inner core into banana pseudostem particles within an appropriate size range prior to boiling or addition of enzymatic inhibitors may greatly improve the effectiveness of the final taste-enhancing and/or texture-modifying food additive and that of the final food product as well. If the particles are too small, then it is more difficult to store moisture with tastant in them and/or the texture, density, or volume may be less desirable. If the particles are too large, then it is more difficult encapsulate sufficient moisture with tastant in them, especially per volume, and the longer fiber particles may be difficult or undesirable to eat and/or they may have an adversem effect on the consistency of the food structure. Any method of breaking up the banana pseudostem may be employed, such as cutting, chopping, dicing, crushing, squeezing, or grinding. Some current methods for size selection involve sifting.

In one example, the banana pseudostem may be broken up into banana-pseudostem particles having a size that is greater than or equal to 1 cu mm (0.000061 cu inch) and less than or equal to 16387 cu mm (1 cu inch). In some embodiments, greater than or equal to 60% of the banana-pseudostem particles have a size that is greater than or equal to 1 cu mm (0.000061 cu inch) and less than or equal to 16387 cu mm (1 cu inch). In some embodiments, greater than or equal to 70% of the banana-pseudostem particles have a size that is greater than or equal to 1 cu mm (0.000061 cu inch) and less than or equal to 16387 cu mm (1 cu inch). In some embodiments, greater than or equal to 80% of the banana-pseudostem particles have a size that is greater than or equal to 1 cu mm (0.000061 cu inch) and less than or equal to 16387 cu mm (1 cu inch). In some embodiments, greater than or equal to 90% of the banana-pseudostem particles have a size that is greater than or equal to 1 cu mm (0.000061 cu inch) and less than or equal to 16387 cu mm (1 cu inch). In some embodiments, greater than or equal to 95% of the banana-pseudostem particles have a size that is greater than or equal to 1 cu mm (0.000061 cu inch) and less than or equal to 16387 cu mm (1 cu inch). In some embodiments, greater than or equal to 99% of the banana-pseudostem particles have a size that is greater than or equal to 1 cu mm (0.000061 cu inch) and less than or equal to 16387 cu mm (1 cu inch).

In another example, the banana pseudostem may be broken up into banana-pseudostem particles having a size that is greater than or equal to 8 cu mm (0.0005 cu inch) and less than or equal to 2048 cu mm (0.125 cu inch). In some embodiments, greater than or equal to 60% of the banana-pseudostem particles have a size that is greater than or equal to 8 cu mm (0.0005 cu inch) and less than or equal to 2048 cu mm (0.125 cu inch). In some embodiments, greater than or equal to 70% of the banana-pseudostem particles have a size that is greater than or equal to 8 cu mm (0.0005 cu inch) and less than or equal to 2048 cu mm (0.125 cu inch). In some embodiments, greater than or equal to 80% of the banana-pseudostem particles have a size that is greater than or equal to 8 cu mm (0.0005 cu inch) and less than or equal to 2048 cu mm (0.125 cu inch). In some embodiments, greater than or equal to 90% of the banana-pseudostem particles have a size that is greater than or equal to 8 cu mm (0.0005 cu inch) and less than or equal to 2048 cu mm (0.125 cu inch). In some embodiments, greater than or equal to 95% of the banana-pseudostem particles have a size that is greater than or equal to 8 cu mm (0.0005 cu inch) and less than or equal to 2048 cu mm (0.125 cu inch). In some embodiments, greater than or equal to 99% of the banana-pseudostem particles have a size that is greater than or equal to 8 cu mm (0.0005 cu inch) and less than or equal to 2048 cu mm (0.125 cu inch).

In another example, the banana pseudostem may be broken up into banana-pseudostem particles that have a major dimension that is greater than or equal to 1 mm (0.04 inch) and less than or equal to 10 mm (0.4 inch). In some embodiments, greater than or equal to 70% of the banana-pseudostem particles have a major dimension that is greater than or equal to 1 mm (0.04 inch) and less than or equal to 10 mm (0.4 inch). In some embodiments, greater than or equal to 80% of the banana-pseudostem particles have a major dimension that is greater than or equal to 1 mm (0.04 inch) and less than or equal to 10 mm (0.4 inch). In some embodiments, greater than or equal to 90% of the banana-pseudostem particles have a major dimension that is greater than or equal to 1 mm (0.04 inch) and less than or equal to 10 mm (0.4 inch). In some embodiments, greater than or equal to 95% of the banana-pseudostem particles have a major dimension that is greater than or equal to 1 mm (0.04 inch) and less than or equal to 10 mm (0.4 inch). In some embodiments, greater than or equal to 99% of the banana-pseudostem particles have a major dimension that is greater than or equal to 1 mm (0.04 inch) and less than or equal to 10 mm (0.4 inch).

In another example, the banana pseudostem may be broken up into banana-pseudostem particles that have a major dimension that is greater than or equal to 2 mm (0.08 inch) and less than or equal to 7 mm (0.28 inch). In some embodiments, greater than or equal to 60% of the banana-pseudostem particles have a major dimension that is greater than or equal to 2 mm (0.08 inch) and less than or equal to 7 mm (0.28 inch). In some embodiments, greater than or equal to 70% of the banana-pseudostem particles have a major dimension that is greater than or equal to 2 mm (0.08 inch) and less than or equal to 7 mm (0.28 inch). In some embodiments, greater than or equal to 80% of the banana-pseudostem particles have a major dimension that is greater than or equal to 2 mm (0.08 inch) and less than or equal to 7 mm (0.28 inch). In some embodiments, greater than or equal to 90% of the banana-pseudostem particles have a major dimension that is greater than or equal to 2 mm (0.08 inch) and less than or equal to 7 mm (0.28 inch). In some embodiments, greater than or equal to 95% of the banana-pseudostem particles have a major dimension that is greater than or equal to 2 mm (0.08 inch) and less than or equal to 7 mm (0.28 inch). In some embodiments, greater than or equal to 99% of the banana-pseudostem particles have a major dimension that is greater than or equal to 2 mm (0.08 inch) and less than or equal to 7 mm (0.28 inch).

In another example, the banana pseudostem is broken up into banana-pseudostem particles that have a major dimension that is greater than or equal to 2 mm (0.08 inch) and less than or equal to 4 mm (0.16 inch). In some embodiments, greater than or equal to 50% of the banana-pseudostem particles have a major dimension that is greater than or equal to 2 mm (0.08 inch) and less than or equal to 4 mm (0.16 inch). In some embodiments, greater than or equal to 60% of the banana-pseudostem particles have a major dimension that is greater than or equal to 2 mm (0.08 inch) and less than or equal to 4 mm (0.16 inch). In some embodiments, greater than or equal to 70% of the banana-pseudostem particles have a major dimension that is greater than or equal to 2 mm (0.08 inch) and less than or equal to 4 mm (0.16 inch). In some embodiments, greater than or equal to 80% of the banana-pseudostem particles have a major dimension that is greater than or equal to 2 mm (0.08 inch) and less than or equal to 4 mm (0.16 inch). In some embodiments, greater than or equal to 90% of the banana-pseudostem particles have a major dimension that is greater than or equal to 2 mm (0.08 inch) and less than or equal to 4 mm (0.16 inch). In some embodiments, greater than or equal to 95% of the banana-pseudostem particles have a major dimension that is greater than or equal to 2 mm (0.08 inch) and less than or equal to 4 mm (0.16 inch). In some embodiments, greater than or equal to 99% of the banana-pseudostem particles have a major dimension that is greater than or equal to 2 mm (0.08 inch) and less than or equal to 4 mm (0.16 inch).

One may appreciate that a given banana-pseudostem food additive may employ banana-pseudostem particles in a single size and/or major dimension range. However, mixing banana-pseudostem food additives having different sizes can be used to great advantage. For example, a high percentage of smaller size and/or major dimension range, which can have a more homogenous-like effect, can be mixed with a high percentage of larger size and/or major dimension range, which can have a more intense effect (like raisons in a muffin).

In some embodiments, the method further comprises the step of mixing the banana-pseudostem particles with one or more preservatives. The preservatives can be added to the soaking medium, the boiling medium, or after boiling. Some of the selected additives which can be used as enzyme deactivating agents/enzyme oxidation inhibitors in this process are turmeric, capsicum, salt, sugar, potassium sorbate, sodium metabisulfite, or similar products within an acidic medium. Turmeric and capsicum, which are natural additives, and potassium sorbate and sodium metabisulfite cause minimum added adverse taste during the treatment. Sugar and salt when used as additives affect taste and may or may not contribute to color change during the treatment process.

Adding natural spices, such as turmeric and capsicum may act as antioxidants to minimize enzyme reaction of banana stem inner core, inhibiting the enzymic reaction of lignin oxidation and minimizing color change and bittering effect. However, turmeric and capsicum add some authentic taste, which may be useful in some circumstances and disadvantageous in others. For spicy and/or savory (umami) tastes and darker food products, the color and taste changes may be desirable. Potassium sorbate and sodium metabisulfite also chemically minimize lignin oxidation, and salt and sugar more or less act as physical inhibitors of lignin oxidation within acidic mediums. Regardless of the variations, such treatments to the banana stem provide a low-calorie carrier for tastants provides vastly fewer calories than commonly added with high-intensity sweeteners, such as aspartame and stevia, to dilute the intensity of such sweeteners. (One will appreciate, however, that even high-intensity sweeteners, such as aspartame and stevia, can be added as a tastant, but in greatly diminished amounts, to a banana-pseudostem particle mixture to provide a sweet food additive without all of the extra calories of other carriers.)

In some embodiments, a method of preparing a food additive comprises: providing a banana plant stem; removing the outer layers of the banana plant stem to expose its inner core; soaking (treating) in an acidic medium (3-6.8 pH) for from 1 day up to 16 weeks, reducing the particle size; boiling the inner core for about 10 to 120 minutes in an aqueous medium; reducing the water content of the boiled inner core; and adding tastants. In some embodiments, the inner core is boiled in an acidic aqueous medium that is controlled in between the pH from 3 to 6.5. In some embodiments, the inner core is boiled in an aqueous medium that is controlled in between the pH from 6.0 to 8.0. In some embodiments, the inner core is boiled at atmospheric pressure. In other embodiments, the inner core is boiled at elevated pressure. In still further embodiments, the inner core is boiled at elevated pressure for less than 30 minutes.

In some embodiments, the inner core is boiled at a temperature of from about 200° F. to about 250° F. In some embodiments, the inner core is boiled at a temperature of from about 205° F. to about 245° F. In some embodiments, the inner core is boiled at a temperature of from about 210° F. to about 240° F. In some embodiments, the inner core is boiled at a temperature of from about 215° F. to about 235° F. In some embodiments, the inner core is boiled at a temperature of from about 220° F. to about 230° F. In some embodiments, the inner core is boiled at a temperature of about 225° F.

In some embodiments, the methods further comprise the step of sterilizing the boiled inner core. In some embodiments, the boiled inner core is sterilized in an autoclave. In some embodiments, the boiled inner core is sterilized in an autoclave (conventional or microwave) at temperature of from about 175° F. to about 250° F. In some embodiments, the boiled inner core is sterilized in an autoclave (conventional or microwave) at temperature of from about 175° F. to about 250° F. for from about 30 to about 80 minutes.

Some embodiments pack the sterilized inner core or banana-pseudostem particles in a vessel, such as a bottle or a bag. In some embodiments, the vessel is hermetically sealed. The vessel can be of any shape and comprise any food-safe material that is compatible with maintaining freshness of the banana pseudostem. In some embodiments, the sterilized inner core or banana-pseudostem particles are packed in a vessel containing a liquid medium.

Reducing the water content of boiled (treated) banana stem inner core provides good absorbance properties so that the banana-pseudostem particles absorb the tastant immediately. Therefore, such treated, water-reduced banana stem works as a satisfactory tastant carrier as disclosed herein.

Therefore, it is identified that the advantage of developing such a taste enhancing, texture modifying food product to support the food processing industry. In this process, the signature body of the banana stem inner core is absorbing such tastants and the variety and the amount of tastants used helps to maintain the intensity and complexity of the taste of the final product.

In some embodiments, the inner core is dried at a temperature of from about 85° F. to about 325° F. In some embodiments, the inner core is dried at a temperature of from about 100° F. to about 300° F. In some embodiments, the inner core is dried at a temperature of from about 125° F. to about 275° F. In some embodiments, the inner core is dried at a temperature of from about 150° F. to about 250° F. In some embodiments, the inner core is dried at a temperature of from about 175° F. to about 225° F. In some embodiments, the inner core is dried at a temperature of about 200° F.

In some embodiments, the boiled inner core is sun-dried. In some embodiments, drying of the inner core is facilitated through the use of an oven (e.g. microwave, electric or gas).

In some embodiments, the inner core is dried for from about 2 minutes to about 72 hours. In some embodiments, the inner core is dried for from about 15 minutes to about 60 hours. In some embodiments, the inner core is dried for from about 30 minutes to about 48 hours. In some embodiments, the inner core is dried for from about 45 minutes to about 36 hours. In some embodiments, the inner core is dried for from about 60 minutes to about 24 hours. In some embodiments, the inner core is dried for from about 75 minutes to about 12 hours. In some embodiments, the inner core is dried for from about 90 minutes to about 8 hours. In some embodiments, the inner core is dried for from about 120 minutes to about 6 hours. In some embodiments, the inner core is dried for from about 3 hours to about 5 hours. In some embodiments, the inner core is dried for about 4 hours.

In some embodiments, the inner core is dried to an extent sufficient to provide a water content of from about 0.1% by weight to about 98% by weight. In some embodiments, the inner core is dried to an extent sufficient to provide a water content of from about 1% by weight to about 98% by weight. In some embodiments, the inner core is dried to an extent sufficient to provide a water content of from about 2% by weight to about 98% by weight. In some embodiments, the inner core is dried to an extent sufficient to provide a water content of from about 3% by weight to about 98% by weight. In some embodiments, the inner core is dried to an extent sufficient to provide a water content of from about 5% by weight to about 98% by weight. In some embodiments, the inner core is dried to an extent sufficient to provide a water content of from about 10% by weight to about 98% by weight. In some embodiments, the inner core is dried to an extent sufficient to provide a water content of from about 15% by weight to about 98% by weight. In some embodiments, the inner core is dried to an extent sufficient to provide a water content of from about 20% by weight to about 98% by weight. In some embodiments, the inner core is dried to an extent sufficient to provide a water content of from about 30% by weight to about 98% by weight. In some embodiments, the inner core is dried to an extent sufficient to provide a water content of from about 40% by weight to about 98% by weight. In some embodiments, the inner core is dried to an extent sufficient to provide a water content of from about 50% by weight to about 98% by weight.

In some embodiments, the inner core is dried to an extent sufficient to provide a water content of from about 0.1% by weight to about 10% by weight. In some embodiments, the inner core is dried to an extent sufficient to provide a water content of from about 10% by weight to about 20% by weight. In some embodiments, the inner core is dried to an extent sufficient to provide a water content of from about 20% by weight to about 50% by weight. In some embodiments, the inner core is dried to an extent sufficient to provide a water content of from about 50% by weight to about 85% by weight. In some embodiments, the inner core is dried to an extent sufficient to provide a water content of from about 25% by weight to about 75% by weight. In some embodiments, the inner core is dried to an extent sufficient to provide a water content of from about 10% by weight to about 50% by weight. In some embodiments, the inner core is dried to an extent sufficient to provide a water content of from about 5% by weight to about 95% by weight. In some embodiments, the inner core is dried to an extent sufficient to provide a water content of from about 10% by weight to about 90% by weight. In some embodiments, the inner core is dried to an extent sufficient to provide a water content of from about 10% by weight to about 98% by weight. In some embodiments, the inner core is dried to an extent sufficient to provide a water content of from about 0.1% by weight to about 10% by weight. One will appreciate that alternative ranges between any of these endpoints are also possible.

Further particle size reduction of the water-reduced banana-pseudostem particle mixture may be desirable, especially when an initial size reduction step does not accomplish swizes in the desired ranges as set forth previously. Cutting, crushing, squeezing, grinding, or granulating the water-reduced banana-pseudostem particle mixture may be employed.

Tastants may be added at one or more stages, such as to the soaking or boiling mediums or after water reduction. A tastant may comprise any flavoring agent, such as having a sweet, salty, sour, bitter, or savory taste. Common suitable tastants include sugar, a salt, a spice, monosodium glutamate, milk, cream, vegetable oil, animal fat, starch, a savory broth, soy sauce, citric acid, and acetic acid, other food-acceptable acids, stevia, and artificial sweetners. One or more tastants may be encapsulated together, or they may be encapsulated individually. For example, a banana-pseudostem food additive containing a only an encapsulated sugar tastant may be mixed with a banana-pseudostem food additive containing a only an encapsulated salt tastant.

In some embodiments, particle size-reduced banana plant stem may be used as a carrier of taste encapsulation. In one embodiment, an additive facilitates slow release of such tastants, helping to retain or repeatedly expose their taste on the taste buds of the tongue, which can help decrease or minimize the level of sugar, salt, any other tastants in the food products.

Because the banana-pseudostem particles are a structurally hemicellulose and cellulose tubing that is configured to carry water through the body of the banana plant, such microstructural water tubing can be ideally useful to encapsulate or carry water dissolvable tastants. When the banana hemicellulose and cellulose tubing structures are filled with tastants and used as a food additive, the resulting food additive may act as a slow-release tasting agent. Such soft fibrous structures provide extra chewiness and slowly release the encapsulated moisture with its absorbed tastant as the food product is chewed.

Because the taste-carrying particles of such tastant-enhanced banana pseudostem provide intense and long-lasting taste in the food structure, the rest of the ingredients in the food structure may be provided with fewer or no tastants. Moreover, the total overall amount of tastants may be decreased because the flavor is continually released as the food is chewed. In contradistinction, water soluble tastants that are not encapsulated dissolve quickly in the mouth and do not last long on the tastebuds, so tastants such as sugar and salt are used in huge and unhealthy quantities in most recipes and processed food products.

In some embodiments, the tastants may be encapsulated into the hemicellulose and cellulose tubing structures of the banana-pseudostem particles by a gelatinization process to produce the banana-pseudostem food additive. Gelatinization may be employed during part of the drying process or may employ additional heating or moisture removal. Typically, a gelatinization agent is added, such as starch or gelatin.

In some embodiments, an amimal-based gelatinizing agent is added. In some embodiments, a plant-based gelatinizing agent is added. In some embodiments, a plant-based gelatinizing starch is added. In some embodiments, the plant-based gelatinizing agent may include one or more of tapioca flour, potato flour, corn flour, a gluten-based starch, xanthan gum, molt dextrin, any commercial based food starch or gum, a thickening agent, an oil, a wax. In some embodiments, a corn-based gelatinizing agent is added, such as corn starch or corn syrup. In some embodiments, a combination of gelatinization agents may be added. These gelatinization agents maybe employed with or without additional heat or additional moisture removal.

In some additional, alternative, selectively cumulative embodiments, greater than or equal to 5% of hemicellulose and cellulose tubing structures encapsulate a tastant, greater than or equal to 10% of hemicellulose and cellulose tubing structures encapsulate a tastant, greater than or equal to 20% of hemicellulose and cellulose tubing structures encapsulate a tastant, greater than or equal to 50% of hemicellulose and cellulose tubing structures encapsulate a tastant, or greater than or equal to 75% of hemicellulose and cellulose tubing structures encapsulate a tastant.

Some embodiments relate to methods of manufacturing food additives using banana stem inner core (banana pseudostem) to be used in food product recipes as a flavor enhancer, texture modifier, and/or process improvement additive. Such banana-pseudostem food additives can be used as taste modifiers, carriers of tasting agents, flavor enhancers, flavor retainers, flavor accepters, and/or flavoring agents. Also, such banana pseudostem food additives can be used as texture modifiers, food product softeners, water retainers, volume modifiers, and/or color modifiers.

The banana-pseudostem food additive with tastant(s) encapsulated into the hemicellulose and cellulose tubing structures of the banana-pseudostem particles has an advantageous shelf life. In some embodiments, the banana-pseudostem food additive has a shelf life that is greater than or equal to 1 day, greater than or equal to 10 days, greater than or equal to 20 days, greater than or equal to 30 days, greater than or equal to 2 months, greater than or equal to 4 months, greater than or equal to 6 months, greater than or equal to 12 months, greater than or equal to 18 months, or greater than or equal to 24 months with or without additional preservatives. In some embodiments, the banana-pseudostem food additive has a shelf life that is greater than or equal to 1 month and less than or equal to 2 years with or without additional preservatives. In some embodiments, the banana-pseudostem food additive has a shelf life that is greater than or equal to 1 month and less than or equal to 3 years with or without additional preservatives.

In some embodiments, an additional preservative including one or more of potassium sorbate, sodium metabisulfite, sodium pyrophosphate, sodium nitrate, sodium benzoate, BHT, BHA, or any commercial food preservative may be added to the boiled banana-pseudostem particle mixture or the water-reduced banana-pseudostem particle mixture.

Another aspect of this disclosure relates to using banana pseudostem and to methods of treating it to encapsulate intense taste to use as a tasting agent, taste enhancer, slow taste-releasing additive, or texture modifier of a food additive or food product to minimize sugar, salt, or other tastants in an overall food product.

In some embodiments, a method of preparing a taste-enhancing and/or texture-modifying and/or slow taste-releasing food additive and taste encapsulation method comprises providing banana plant stem, removing outer layers of the banana plant stem to provide its inner core banana pseudostem devoid of removed outer layers, soaking or treating the banana pseudostem in an acidic medium, breaking up the banana pseudostem into banana-pseudostem particles, boiling the banana-pseudostem particles in an aqueous medium to provide a boiled banana-pseudostem particle mixture, removing water from the boiled banana-pseudostem particle mixture to provide a water-reduced banana-pseudostem particle mixture, and adding effective amount of one or more tastants (tasting agents), wherein the tastants comprise one or more of sugar, salt, spice, monosodium glutamate, milk, cream, vegetable oil, animal fat, starch, savory broth, soy sauce, citric acid, acetic acid, adding a starch, gelatin, oil, a processing aid, or combination thereof, heating to gelatinize the additive, and optionally removing additional water.

Some embodiments provide a food product comprising a food additive described herein. Some embodiments provide a food product comprising a food additive prepared by any one of the methods described herein.

Other embodiments provide a food additive comprising: an effective amount of the inner core of a banana plant stem; and an orally acceptable carrier.

In some embodiments, the orally acceptable carrier comprises an ingredient selected from: a colorant; a preservative; a sweetener; an emulsifier; a processing aid; and a combination of two or more thereof. In some embodiments, the processing aid includes starch, colorants, preservatives, softeners, spices, salt, sugar, sugar syrups, homogenizers, emulsifiers, or enzymes.

In some embodiments, the banana stem taste enhancing additive may have a wet, ground/pulp form that is used as a percentage of a food product. In some embodiments, the food product is a processed food product. In some embodiments, the processed food product is selected from: a pastry, pasta, a bread product, a sweet or a savory filling, a sweet paste, savory paste, a sweet mix, a savory mix, a sweet or savory topping, a potato product, a granola bar, a cereal bar, chili paste, pickle, soup, juice, a sauce, a chutney, a dairy product, a gravy, a pet food, a laxative, a stool softener, a batter, a coating, and a meat product. In some embodiments, the food product is selected from a donut, a muffin, a cake, a bagel, a cupcake, and a biscuit. In some embodiments, the pastry is selected from a shortcrust pastry; a flaky pastry; a puff pastry; a choux pastry and a phyllo pastry.

In some embodiments, the bread product is selected from: a baguette, a roll, a bun, naan, pita bread, and a tortilla.

In some embodiments, the potato product is selected from: French fries; tater tots; hash browns; potato chips; and potato sticks.

In some embodiments, the meat product is selected from a fresh processed meat product; a cured meat product; a raw-cooked meat product; a precooked-cooked meat product; a raw-fermented sausage product; and a dried meat product. In some embodiments, the fresh processed meat product is selected from: hamburger; fried sausage; kebab; and chicken nuggets. In some embodiments, the cured meat product is selected from: raw-cured beef; cooked beef; cooked ham; reconstituted products; bacon; and raw ham. In some embodiments, the raw-cooked meat product is selected from: frankfurter; mortadella; lyoner and meat loaf. In some embodiments, the precooked-cooked meat product is selected from: liver sausage; blood sausage; and corned beef. In some embodiments, the raw-fermented sausage product is salami. In some embodiments, the dried meat product is selected from: biltong, beef jerky and meat floss.

In some embodiments, the food product is a lab-grown meat product. In some embodiments, the food product is a plant-based meat product.

In some embodiments, the food product is selected from a snack, a sweet, chocolate-based product, a biscuit, a muffin, a donut, a bagel, a cake and a cupcake.

In some embodiments, the food additive comprises from about 0.1% by weight to about 75% by weight of the food product. In some embodiments, the food additive comprises from about 0.5% by weight to about 50% by weight of the food product. In some embodiments, the food additive comprises from about 0.1% by weight to about 5% by weight of the food product. In some embodiments, the food additive comprises from about 2% by weight to about 10% by weight of the food product. In some embodiments, the food additive comprises from about 3% by weight to about 35% by weight of the food product. In some embodiments, the food additive comprises from about 4% by weight to about 30% by weight of the food product. In some embodiments, the food additive comprises from about 5% by weight to about 25% by weight of the food product. In some embodiments, the food additive comprises from about 6% by weight to about 20% by weight of the food product. In some embodiments, the food additive comprises from about 7% by weight to about 15% by weight of the food product. In some embodiments, the food additive comprises from about 8% by weight to about 12% by weight of the food product. In some embodiments, the food additive comprises about 10% by weight of the food product. In some embodiments, the food additive comprises from about 0.1% by weight to about 50% by weight of the food product. In some embodiments, the food additive comprises from about 2% by weight to about 25% by weight of the food product. In some embodiments, the food additive comprises about 0.01, 0.05, 0.1, 0.2., 0.3, 0.4, 0.5, 1, 2, 3, 4, 5, 6, 7, 8, 9, 10, 11, 12, 13, 14, 15, 20, 25, 30, 35, 40, 45, 50, 55, 60, 65, 70, 75 or 95% by weight of the food product. One will appreciate that alternative ranges between any of these endpoints are also possible.

Further embodiments provide a processed food product comprising: a food additive comprising the inner core of a banana plant stem; and a meat source. In some embodiments, the meat source is selected from beef; turkey; chicken; pork; seafood; and a combination of two or more thereof. The meat source may be selected from lab-grown meat.

Other embodiments provide a fresh food product comprising: a food additive comprising the inner core of a banana plant stem; and an ingredient selected from egg; flour; butter; salt; sugar; yeast; a vegetable; and a combination of two or more thereof.

Some embodiments provide a method of reducing the calorie content in a food product comprising adding an effective amount of any one of the food additives described herein to the food product. In some embodiments, the food additive replaces a carbohydrate (e.g. a starch or sugar). In some embodiments, the food additive replaces a protein. In some embodiments, the food additive replaces a fat.

Further, the processed inner core taste enhancer may be added to any food product, as a fiber additive replacement for protein, carbohydrate or fat. In some embodiments, the food additives described herein reduce the calorie content of a meal.

The invention will be described in greater detail by way of specific examples. The following examples are offered for illustrative purposes and are not intended to limit the invention in any manner. Those skilled in the art will readily recognize a variety of noncritical parameters, which can be changed or modified to yield essentially the same results.

### EXAMPLES

### Example 1

### Savory Mix Paste

Inner core of the banana plant stem is removed by peeling off the outer layers of the stem. The inner core is washed with water, reduce the particle size. Add with turmeric powder, capsicum salt, citric acid and boiled. Once the chunks become softer, drain water. Further water reduction to be 80% to 40%. Add with monosodium glutamate, soy sauce, vegetable oil, beef stock, food starch and further water reduced at high temperature, homogenized and taste optimized as desired.

### Example 2

### Sweet Mix Paste

Inner core of the banana plant stem is removed by peeling off the outer layers of the stem. The inner core is washed with water, reduce the particle size. Add with sugar, salt, citric acid and boiled. Once the chunks become softer, drain water. Further water reduction to be 30% to 25%. Add with, food starch, vegetable shortening, brown sugar, molasses and further water reduced at high temperature and optimize the taste and stability.

### Example 3

### Bread Product

1.5 cups of banana stem sweet paste (as in example 2, 25% moisture content) and 1.5 tablespoons of yeast is added to the vessel. 1 teaspoon of salt and one quarter cup vegetable oil are added to the vessel. Six cups of white bread flour are added to the vessel, one cup at a time. Processed dough is kneaded on a lightly floured surface until smooth. Dough is placed in an oiled bowl to coat, and then covered with a damp cloth. Dough is allowed to rise for about 1 hour. Dough is punched down and then kneaded for a few minutes. Dough is shaped into loaves and placed into an oiled loaf pan. Dough is allowed to rise for about 30 minutes, or until dough has risen 1 inch above pan. Dough is then baked at 350° F. (175° C.) for about 30 minutes. The final product comprises about 25% by weight of the processed inner core.

The Samples prepared with higher concentrations of inner core and/or reduced water content result in less than desirable final products. For example, a product prepared with 35% by weight banana stem sweet paste, having a water content of 25% by weight, may fail to rise to a sufficient extent and may not deliver a desired taste profile.

### Example 4

### Muffin Product

Two cups of all-purpose flour, ½ cup of banana stem sweet paste (25% water content) one tablespoon of baking powder and ½ cup water are mixed in a first vessel. Beat one large egg in a second vessel and add one cup whole milk and ½ teaspoon vanilla extract to the second vessel. Four tablespoons of melted butter is slowly mixed in with the contents of the second vessel. The contents of the first vessel are mixed gently with the contents of the second vessel. The mixture is poured into a muffin pan and baked at 400° F. for about 20 minutes.

The Samples prepared with higher concentrations banana stem sweet mix, less water content result in less than desirable final products. For example, a muffin product prepared with 30% by weight banana stem sweet paste, having a water content 25% by weight, results in a product that is bulky, too hard, and does not deliver the desired palatability. No salt or sugar added as the banana stem sweet mix provides sweet and salt taste combination

### Example 5

### Fast Food Meat Product

Described below in Table 1 is an exemplary fast food meat product of the present invention, which comprises the banana stem inner core tasting agent, prepared according to an inventive method of the present invention.

TABLE 1

| Ingredient | Amount |
|---|---|
| Meat Source | 450 |
| Banana plant stem inner core tasting agent | 100 |
| Preservative | 0.01-0.05 |
| Egg yolk | 40 |
| Chopped onion | 50 |
| Bread crumbs | 40 |

Meat products prepared with up to 22% by weight of banana plant stem tasting agent, result in a product without a perceptible taste difference. However, products prepared with greater than 30% by weight of banana plant stem tasting agent results in an undesirable taste, more salty and sour, and not stable by the structure for processing.

### Example 6

### Fast Food Potato Product

Described below in Table 2 is an exemplary fast food potato product of the present invention, which comprises banana stem inner core tasting agent, prepared according to an inventive method of the present invention.

TABLE 2

| Ingredient | % by weight |
|---|---|
| Potato source | 70 |
| Banana plant stem tasting agent | 24 |
| Canola oil | 2.0-3.0 |
| Sodium acid pyrophosphate | 0.01-0.05 |
| Bread crumbs | 1.0-2.0 |

### Example 7

### Granola Bar

Described below in Table 3 is an exemplary fast food potato product of the present invention, which comprises banana stem inner core tasting agent, prepared according to an inventive method of the present invention.

TABLE 3

| Ingredient | % by weight |
|---|---|
| Whole rolled oats | 40 |
| Whole grain wheat flour | 20 |
| Banana plant stem tasting agent | 30 |
| Canola oil | 2.0-3.0 |
| Sodium acid pyrophosphate | 0.01-0.05 |
| Chopped dried fruits | 5.0-7.0 |

### Example 8

### Breakfast Pan Cake

Ingredients; 1 cup of all-purpose flour, ½ cup of banana stem sweet mix, 2 teaspoons of baking powder, 1 cup of milk, one large egg, 1 tablespoon of vegetable oil. In a large bowl, mix together flour and banana stem sweet mix. Add with milk and the oil and mix until smooth. Heat a lightly oiled griddle or frying pan over medium-high heat. Pour or scoop the batter into the griddle to make pancake and keep and turn until brown on each side.

### Example 9

### Freshly Made Instant Noodle Soup

Ingredients; 1 cup of dry instant noodle. ½ cup of banana stem savory mix. 2 table spoons of chopped onion. 1 table spoon of butter. Add butter into a hot pan and add chopped onion keep onion turn into brown color. Add banana stem savory mix into it and mix together. Add water and noodles into the pan and simmer it for 2-3 minutes to prepare much tastier noodle soup.

### Example 10

### Freshly Prepared Egg Omelet

Add 100 grams of banana stem savory mix to a vessel containing two eggs. Place in a warm buttered skillet on medium heat and cook for 2-3 minutes or until eggs harden to the desired extent. The omelet prepared is a flavored savory and salty and satisfactory with texture and taste.

Alternative meat products, such as lab-grown meat products and plant-based meat products, are finally starting to simulate the flavor and texture of some natural animal meat products. Even so, there is much room for improvement. Banana stem food additives can be used as taste enhancers and texture modifiers in these food products. The slow taste-releasing properties of the banana-pseudostem flavor-enhancing or texture modifying food additive can offer big advantages to these food products.

With respect to plant-based meat products, the manufacturers of these products have been trying to use plant food ingredients to imitate a meat-like taste and texture. In particular, a number of companies have tried to imitate the taste and texture of beef burger. However, even though these products have become more palatable and have acquired some market acceptance, these plant-base meat products are still far from matching the quality, taste, and texture of the real animal meat products.

Real animal meat provides desirable squeezing texture, moisture, fibrous structure and slow taste release with a meaty or umami taste. The plant-based meat products in the current market are generally made with pea products, TVP (Textured Vegetable Protein), soy, vegetable fat, tastants, colorants, and some spices. The texture capabilities of the banana-pseudostem flavor-enhancing or texture modifying food additive can deliver a texture not available from the contemporary plant-based meat product ingredients; and, the tastant capabilities of the banana-pseudostem flavor-enhancing or texture modifying food additive can deliver a method of slow-release tastant (and/or moisture) not available from the contemporary plant-based meat product ingredients.

Two examples of recipes for a plant-based meat burger patty that includes the banana-pseudostem flavor-enhancing or texture modifying food additive are provided below. These patties can be fried, baked, or microwaved.

### Example 11

### Plant-Based Imitation Meat Burger Patty #1

TABLE 4

| Ingredient | Amount (g) |
|---|---|
| TVP- Chopped | 100 |
| Pea Powder | 60 |
| Coconut Oil | 10 |
| Powdered Onion | 5 |
| Banana plant stem inner core tasting agent | 20 |

### Example 12

### Plant-Based Imitation Meat Burger Patty #2

TABLE 5

| Ingredient | Amount (g) |
|---|---|
| Soy-Based Dry TVP | 100 |
| Fermented soy mixture | 100 |
| Vegetable fat | 20 |
| Powdered Onion | 5 |
| Vegetable broth | 35 |
| Banana plant stem inner core tasting agent | 25 |

Lab-grown meat products are still more experimental than commercial but offer potential cost and health advantages over livestock production. Unfortunately, lab-grown meat products have thus far not been able to mimic the natural taste and the texture of real meat products. Achieving real meat fibrous structure has been a particular challenge. However, the added texture of the banana-pseudostem flavor-enhancing or texture modifying food additive can address this issue to provide a satisfactory fibrous structure while providing a tailored slow-releasing taste. The mixture of lab-grown meat products with the banana-pseudostem flavor-enhancing or texture modifying food additive can make food products using contemporary meat product recipes with the simple substitution of the lab-grown meat and banana-pseudostem food additive mixture.

Skilled persons will appreciate that the subject matter of any sentence or paragraph can be combined with subject matter of some or all of the other sentences or paragraphs, except where such combinations are mutually exclusive.

### CONCLUSION

The terms and descriptions used above are set forth by way of examples only and are not meant as limitations. Those skilled in the art will recognize that many variations, enhancements and modifications of the concepts described herein are possible without departing from the underlying principles of the invention.

1. A method of preparing a banana-pseudostem food additive for modifying taste or texture, comprising:
removing outer layers of a banana plant stem to provide a banana pseudostem devoid of removed outer layers;
optionally soaking the banana pseudostem in a first soaking aqueous medium;
breaking up the banana pseudostem to produce banana-pseudostem particles so that greater than or equal to 60% of the banana-pseudostem particles have a size that is greater than or equal to 1 cu mm (0.000061 cu inch) and less than or equal to 16387 cu mm (1 cu inch) and such that the banana-pseudostem particles provide hemicellulose and cellulose tubing structures;
optionally soaking the banana-pseudostem particles in a second soaking aqueous medium;
boiling the banana-pseudostem particles in a boiling aqueous medium, wherein banana pseudostem or banana-pseudostem particles are subjected to an acid treatment in one or more of the first soaking aqueous medium, the second soaking aqueous medium, or the boiling aqueous medium to provide a boiled banana-pseudostem particle mixture;
reducing water from the boiled banana-pseudostem particle mixture to provide a water-reduced banana-pseudostem particle mixture having a water content that is from about 2% by weight to about 95% by weight; and
adding an effective amount of one or more tastants to produce a banana-pseudostem food additive such that greater than or equal to 1% of the hemicellulose and cellulose tubing structures encapsulate a tastant.

2. The method of claim 1, wherein the banana-pseudostem particles provide hemicellulose and cellulose tubing structures, and wherein greater than or equal to 10% of hemicellulose and cellulose tubing structures encapsulate a tastant.

3. The method of claim 1, wherein the banana-pseudostem particles provide hemicellulose and cellulose tubing structures, and wherein greater than or equal to 50% of hemicellulose and cellulose tubing structures encapsulate a tastant.

4. The method of claim 1, wherein greater than or equal to 90% of the banana-pseudostem particles have a size that is greater than or equal to 1 cu mm (0.000061 cu inch) and less than or equal to 16387 cu mm (1 cu inch).

5. The method of claim 1, wherein greater than or equal to 60% of the banana-pseudostem particles have a size that is greater than or equal to 8 cu mm (0.0005 cu inch) and less than or equal to 2048 cu mm (0.125 cu inch).

6. The method of claim 1, wherein greater than or equal to 60% of the banana-pseudostem particles have a major dimension that is greater than or equal to 2 mm (0.08 inch) and less than or equal to 7 mm (0.28 inch).

7. The method of claim 1, further comprising:
after the step of boiling the banana-pseudostem particles, subjecting them to high heat.

8. The method of claim 1, further comprising:
after the step of boiling the banana-pseudostem particles, subjecting them to a temperature greater than or equal to about 204.444 (400° F.).

9. The method of claim 1, further comprising:
after the step of boiling the banana-pseudostem particles, subjecting them to further fragmentation or homogenization; and
subjecting them to heat.

10. The method of claim 1, wherein the tastant comprises one or more of an ingredient having a sweet taste, an ingredient having salty taste, an ingredient having bitter taste, an ingredient having sour taste, an ingredient having savory taste, an ingredient having spicy taste, an ingredient having umami taste, and an ingredient having a creamy taste.

11. The method of claim 1, wherein the banana-pseudostem particles are treated in one or more of the first soaking aqueous medium, the second soaking aqueous medium, or the boiling aqueous medium with an enzyme-reaction inhibitor that comprises a bitter-taste-deterring enzyme-reaction inhibitor that permits discoloration of the banana-pseudostem particles.

12. The method of claim 1, wherein the banana-pseudostem particles are treated in one or more of the first soaking aqueous medium, the second soaking aqueous medium, or the boiling aqueous medium with an enzyme-reaction inhibitor that comprises one or more of turmeric, capsicum, salt, an acid, or sugar.

13. The method of claim 1, further comprising:
encapsulating the tastants within the banana-pseudostem particles by gelatinization to produce the banana-pseudostem food additive.

14. The method of claim 1, wherein gelatinization employs addition of starch or gelatin.

15. The method of claim 1, wherein one or more of the first soaking aqueous medium, the second soaking aqueous medium, or the boiling aqueous medium has a pH that is greater than or equal to 2 and less than or equal to 6.5.

16. The method of claim 1, wherein the step of breaking up the banana pseudostem to produce banana-pseudostem particles occurs before the step of boiling, allowing for effective enzyme deactivation process.

17. The method of claim 1, wherein a processing aid, an orally acceptable carrier, or an additional tastant is added during or after the step of adding tastants, wherein the processing aid comprises one or more of starch, vegetable oil, butter, cream, fatty acids, and animal fat, or wherein the orally acceptable carrier comprises one or more of a colorant, preservative, a sweetner, and an emulsifier.

18. The method of claim 1, wherein the banana-pseudostem food additive contains from 0.1% to 99% by weight as a taste enhancer or texture modifier or additive in a food product wherein the food additive delivers the taste of sweet, bitter, salty, sour, savory, spicy, umami, creamy, or combination of such tastes to a food product.

19. The method of claim 18, wherein the food product is one or more of a pastry, pasta, a bakery product, bread product, a sweet or savory filling, a sweet product, a sweet or savory topping, a potato product, a granola bar, a serial bar, chili paste, soup, juice, a sauce, a pickle, a chutney, a diary product, a gravy, a pet food, a laxative, a stool softener, a batter, a coating, a paste, a concentrate, and a meat product.

20. The method of claim 18, wherein the food product is a plant-based meat product or a lab-grown meat product.

21. The method of claim 1, wherein the enzyme-reaction inhibitor comprises a bitter-taste-deterring enzyme-reaction inhibitor that permits discoloration of the banana-pseudostem particles, wherein the banana-pseudostem particles are boiled for greater than or equal to 10 minutes at a temperature greater than or equal to 104.444° C. (220° F.), wherein reducing water from the boiled banana-pseudostem particles provides the water-reduced banana pseudostem particle mixture with a water content that is greater than or equal to about 10% by weight to about 95% by weight, and wherein the banana-pseudostem food additive is configured for preparation of a food product having 0.1% to 50% by weight of the food additive.

22. The method of claim 1, wherein the banana-pseudostem food additive functions as one or more of a flavor enhancer, a texture modifier, and a slow taste-releasing agent.

23. The method of claim 1, wherein the tastant is encapsulated within banana-pseudostem particles by gelatinization by adding an effective amount of one or more of starch, gelatin, oil, or a processing aid.

24. The method of claim 1, wherein the tastant is encapsulated within banana-pseudostem particles by gelatinization by adding effective amount of one or more of starch, gelatin, oil, or a processing aid to provide a gelatinized pseudostem-tastant mixture, wherein the gelatinized pseudostem-tastant mixture is heated and its moisture content is further reduced.

25. The method of claim 1, wherein the banana-pseudostem or the banana pseudostem particles are soaked in the first soaking medium or the second soaking medium; wherein greater than or equal to 60% of the banana-pseudostem particles have a size that is greater than or equal to 8 cu mm (0.0005 cu inch) and less than or equal to 2048 cu mm (0.125 cu inch); wherein the banana-pseudostem particles are boiled for longer than or equal to 2 minutes at a temperature greater than or equal to 104.444° C. (220° F.); wherein the tastant comprises one or more of an ingredient having a sweet taste, an ingredient having salty taste, an ingredient having bitter taste, an ingredient having sour taste, an ingredient having savory taste, an ingredient having spicy taste, an ingredient having umami taste, or an ingredient having a creamy taste; wherein a gelatinizing agent is employed to encapsulated the tatant within the banana-pseudostem particles by gelatinization, wherein the gelatinizing agent comprises one or more of starch or gelatin; wherein reducing water from the boiled banana-pseudostem particles provides the water-reduced banana pseudostem particle mixture with a water content that is greater than or equal to about 5% by weight to about 95% by weight.

26. A banana-pseudostem food additive for modifying taste or texture, comprising:
boiled banana-pseudostem particles devoid of outer layers of the banana plant stem, wherein greater than or equal to 60% of the banana-pseudostem particles have a size that is greater than or equal to 1 cu mm (0.000061 cu inch) and less than or equal to 16387 cu mm (1 cu inch), and wherein the banana-pseudostem particles provide hemicellulose and cellulose tubing structures;
a water content that is from about 5% by weight to about 95% by weight; and
a tastant encapsulated within some of the hemicellulose and cellulose tubing structures, wherein greater than or equal to 1% of hemicellulose and cellulose tubing structures encapsulate a tastant.

27. The banana-pseudostem food additive of claim 26, wherein the banana-pseudostem particles provide hemicellulose and cellulose tubing structures, and wherein greater than or equal to 20% of hemicellulose and cellulose tubing structures encapsulate a tastant.

28. The banana-pseudostem food additive of claim 26, wherein the banana-pseudostem particles provide hemicellulose and cellulose tubing structures, and wherein greater than or equal to 50% of hemicellulose and cellulose tubing structures encapsulate a tastant.

29. The banana-pseudostem food additive claim 26, wherein greater than or equal to 90% of the banana-pseudostem particles have a size that is greater than or equal to 2 mm (0.08 inch) and less than or equal to 7 mm (0.28 inch).

30. The banana-pseudostem food additive of claim 26, wherein greater than or equal to 50% of the banana-pseudostem particles have a major dimension that is greater than or equal to 2 mm (0.08 inch) and less than or equal to 4 mm (0.16 inch).

31. The banana-pseudostem food additive of claim 26, wherein greater than or equal to 90% of the banana-pseudostem particles have a major dimension that is greater than or equal to 2 mm (0.08 inch) and less than or equal to 4 mm (0.16 inch).

32. A food product including the banana-pseudostem food additive of claim 26, comprising:
5% to 30% less of the tastant than an equivalent food product has of the tastant.

33. The method of claim 26, wherein the food product is one or more of a pastry, pasta, a bakery product, bread product, a sweet or savory filling, a sweet product, a sweet or savory topping, a potato product, a granola bar, a serial bar, chili paste, soup, juice, a sauce, a pickle, a chutney, a diary product, a gravy, a pet food, a laxative, a stool softener, a batter, a coating, a paste, a concentrate, and a meat product.

34. The method of claim 26, wherein the food product is a plant-based meat product or a lab-grown meat product.
